(19) United States
(12) Patent Application Publication
(10) Pub. No.: US 2010/0153107 A1
(43) Pub. Date: Jun. 17, 2010

(54) TREND EVALUATION DEVICE, ITS METHOD, AND PROGRAM

(75) Inventor: Hideki Kawai, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 12/067,913

(22) PCT Filed: Sep. 25, 2006
(86) PCT No.: PCT/JP2006/318921

§ 371 Date: Mar. 24, 2008

(30) Foreign Application Priority Data
Sep. 30, 2005 (JP) 2005-288429

(51) Int. Cl. G10L 23/00; G09G 5/00; G06Q 99/00

(52) U.S. Cl. 704/240; 345/156; 705/347; 704/E15.014

(57) ABSTRACT

A trend evaluation device includes trend evaluation means having at least one of relative cooccurrence probability calculation means for calculating a change of cooccurrence probability of a keyword and an associated word and relative associated word similarity calculation means for calculating a change degree of a conversation topic concerning the keyword, so as to calculate a trend score by considering one or more combinations of the relative cooccurrence probability and the relative associated word similarity obtained by these means.

### TECHNICAL FIELD

The present invention relates to a trend evaluation apparatus, and a method and a program thereof, and particularly, to a trend evaluation apparatus, and a method and a program thereof capable of evaluating a trend word whose associated word undergoes a significant change.

### BACKGROUND ART

In recent years, business companies such as content providers or on-line shops become capable of dealing with a more massive amount of products and content services (hereinbelow, products and content services will be collectively referred to simply as goods) as EC (Electronic Commerce) is increasingly widespread. On the other hand, it becomes difficult to recommend or promote appropriate goods to users at appropriate times. One promoting method that may be contemplated involves recommending goods that the company deals with in association with trends or popularities that acquire public attention. However, this whole method manually operated by a recommender (which will be referred to as promoter) of goods is time-consuming and cumbersome for two reasons as follows:

(1) it is difficult to decide what is a trend (that is, since sensitivity to popularity varies among individuals, different promoters provide different levels of quality); and

(2) it is difficult to search for associated goods fitted to a trend (selection and search for keywords associated with a trend are time-consuming).

A technique for automatically detecting trends or popularities that acquire public attention is disclosed in Patent Document below:

[Patent Document 1] JP-P1995-325832A

In accordance with the invention disclosed in Patent Document 1, a temporal change in an appearance probability (relative appearance) of a word can be calculated from a time series text, such as newspapers, so that a promoter can objectively determine the trendiness of that word and perform a search as follows:

(1) a search for a word having a high relative appearance in a specified field and period of time;

(2) a search for a period of time in which a specified word has a high relative appearance in a specified field;

(3) in a period of time in which a specified word has a high relative appearance in a specified field, a search for another word having a high relative appearance as well;

(4) a search for a field and a period of time in which a specified word has a high relative appearance; and

(5) in a field and a period of time in which a specified word has a high relative appearance, a search for another word having a high relative appearance as well.

### DISCLOSURE OF THE INVENTION

### Problems to be Solved by the Invention

A problem of the conventional trend evaluation described in Patent Document 1 is that only the word having a high relative appearance can be detected as a trend word. This is because only a relative appearance is used to decide trendiness of a word.

The present invention has been made in view of the above-described problem, and its object is to provide a trend evaluation apparatus, and a method and a program thereof capable of evaluating/detecting, as a trend word, a word whose relative appearance is not high but whose associated word undergoes a significant change.

### Means for Solving the Problems

The 1st invention for solving the above-mentioned task, which is a trend evaluation apparatus, is characterized in that the apparatus has: relative co-occurrence calculating means for calculating a relative co-occurrence that is an indication indicating a change in a co-occurrence probability of a keyword and an associated word of this keyword; and trend evaluating means for evaluating a trend of said keyword based on the relative co-occurrence calculated by said relative co-occurrence calculating means.

The 2nd invention for solving the above-mentioned problem, in the above-mentioned 1st invention, is characterized in that said relative co-occurrence calculating means is means for calculating a relative co-occurrence from a ratio of a co-occurrence probability of the keyword and an associated word of this keyword in a period of time of interest to a co-occurrence probability of said keyword and an associated word of this keyword in a period of time for comparison.

The 3rd invention for solving the above-mentioned problem, in the above-mentioned 1st or 2nd inventions, is characterized in that said trend evaluating means is means for evaluating a combination of a keyword having the largest relative co-occurrence and an associated word of this keyword as a trend.

The 4th invention for solving the above-mentioned problem, in the above-mentioned 1st or 2nd inventions, is characterized in that said trend evaluating means is means for evaluating a combination of a keyword having a relative co-occurrence which exceeds a predetermined threshold value and an associated word of this keyword as a trend.

The 5th invention for solving the above-mentioned problem, in the above-mentioned 1st or 2nd inventions, is characterized in that said trend evaluating means is means for accumulating a relative co-occurrence within a predetermined period of time to obtain a variance value, and evaluating a combination of a keyword corresponding to said variance value which exceeds a predetermined threshold value and an associated word of this keyword as a trend.

The 6th invention for solving the above-mentioned problem, which is a trend evaluation apparatus, is characterized in that the apparatus has: relative associated word similarity calculating means for calculating a relative associated word similarity that is an indication of a degree of a change in a topic for a keyword; and trend evaluating means for evaluating a trend of said keyword based on the relative associated word similarity calculated by said relative associated word similarity calculating means.

The 7th invention for solving the above-mentioned problem, in the above-mentioned 6th invention, is characterized in that said relative associated word similarity calculating means is means for calculating a relative associated word similarity from a cosine similarity of associated word collection vectors of a keyword in a period of time for comparison and associated word collection vectors of said keyword in a period of time of interest.

The 8th invention for solving the above-mentioned problem, in the above-mentioned 6th or 7th inventions, is characterized in that said trend evaluating means is means for evaluating a keyword having the smallest relative associated word similarity as a trend.

The 9th invention for solving the above-mentioned problem, in the above-mentioned 6th or 7th inventions, characterized in that said trend evaluating means is means for evaluating a keyword having a relative associated word similarity smaller than a predetermined threshold value as a trend.

The 10th invention for solving the above-mentioned problem, in the above-mentioned 6th or 7th inventions, is characterized in that said trend evaluating means is means for accumulating a relative associated word similarity over a predetermined period of time to obtain a variance value thereof, and evaluating the relative associated word similarity corresponding to said variance value that exceeds a predetermined threshold value as a trend.

The 11th invention for solving the above-mentioned problem, which is a trend evaluation apparatus, is characterized in that the apparatus has: relative co-occurrence calculating means for calculating a relative co-occurrence that is an indication indicating a change in a co-occurrence probability of a keyword and an associated word of this keyword; relative associated word similarity calculating means for calculating a relative associated word similarity that is an indication of a degree of a change in a topic for said keyword; and trend score calculating means for calculating a trend score for representing trendiness of said keyword in a numerical form based on the relative co-occurrence calculated by said relative co-occurrence calculating means and the relative associated word similarity calculated by said relative associated word similarity calculating means.

The 12th invention for solving the above-mentioned problem, in the above-mentioned 11th invention, is characterized in that said apparatus has trend evaluating means for evaluating a trend of said keyword based on said trend score.

The 13th invention for solving the above-mentioned problem, in the above-mentioned 11th or 12th inventions, is characterized in that said apparatus has relative appearance calculating means for calculating relative appearance that is an indication of a degree of rise of attention to a keyword, and said trend score calculating means calculates a trend score for representing trendiness of said keyword in a numerical form based on the relative co-occurrence calculated by said relative co-occurrence calculating means, the relative associated word similarity calculated by said relative associated word similarity calculating means and the relative appearance calculated by said relative appearance calculating means.

The 14th invention for solving the above-mentioned problem, in any one of the above-mentioned 11th to 13th inventions, is characterized in that said relative appearance calculating means is means for calculating relative appearance from a ratio of an appearance probability of a keyword in a period of time of interest to an appearance probability of said keyword in a period of time for comparison.

The 15th invention for solving the above-mentioned problem, in any one of the above-mentioned 11th to 14th inventions, is characterized in that said trend score calculating means calculates a trend score after weighting said relative co-occurrence, said relative associated word similarity or said relative appearance.

The 16th invention for solving the above-mentioned problem, in any one of the above-mentioned 11th to 15th inventions, is characterized in that said apparatus has trend visualizing means for defining said relative co-occurrence, said relative associated word similarity or said relative appearance as a graphic and displaying it.

The 17th invention for solving the above-mentioned problem, in any one of the above-mentioned 11th to 16th inventions, is characterized in that said apparatus has: goods information storing means in which information on goods is stored; and goods recommending means for searching goods associated with a keyword based on a result of said trend evaluating means from said goods information storing means, and proposing them.

The 18th invention for solving the above-mentioned problem, in any one of the above-mentioned 11th to 17th inventions, is characterized in that said apparatus has cyclicity deciding means for deciding cyclicity of a trend score of a keyword, and correcting the trend score in accordance with the cyclicity.

The 19th invention for solving the above-mentioned problem, in any one of the above-mentioned 11th to 18th inventions, is characterized in that said apparatus has: goods information storing means in which information on goods is stored; customer information storing means in which customer information on a customer is stored; and goods recommending means for searching goods associated with a keyword based on a result of said trend evaluating means from said goods information storing means, and searching a customer to whom these goods are to be recommended from said customer information storing means based on said customer information and proposing them.

The 20th invention for solving the above-mentioned problem, in the above-mentioned 19th invention, is characterized in that said apparatus has update means for updating customer information in said customer information storing means based on a sales track record.

The 21st invention for solving the above-mentioned problem is characterized in that a trend evaluation method comprises the steps of: calculating a relative co-occurrence that is an indication indicating a change in a co-occurrence probability of a keyword and an associated word of this keyword; and evaluating a trend of said keyword based on said calculated relative co-occurrence.

The 22nd invention for solving the above-mentioned problem, in the above-mentioned 21st invention, is characterized in that said relative co-occurrence is a ratio of a co-occurrence probability of the keyword and an associated word of this keyword in a period of time of interest to a co-occurrence probability of said keyword and an associated word of this keyword in a period of time for comparison.

The 23rd invention for solving the above-mentioned problem, in the above-mentioned 21st or 22nd inventions, is characterized in that said step of evaluating a trend comprises step of evaluating a combination of a keyword having the largest relative co-occurrence and an associated word of this keyword as a trend.

The 24th invention for solving the above-mentioned problem, in the above-mentioned 21st or 22nd inventions, is characterized in that said step of evaluating a trend comprises step of evaluating a combination of a keyword having a relative co-occurrence which exceeds a predetermined threshold value and an associated word of this keyword as a trend.

The 25th invention for solving the above-mentioned problem, in the above-mentioned 21st or 22nd inventions, is characterized in that said step of evaluating a trend comprises step of accumulating a relative co-occurrence within a predetermined period of time to obtain a variance value, and evaluating a combination of a keyword corresponding to said variance value which exceeds a predetermined threshold value and an associated word of this keyword as a trend.

The 26th invention for solving the above-mentioned problem is characterized in that a trend evaluation method comprises the steps of: calculating a relative associated word similarity that is an indication of a degree of a change in a topic for a keyword; and evaluating a trend of said keyword based on the calculated relative associated word similarity.

The 27th invention for solving the above-mentioned problem, in the above-mentioned 26th invention, is characterized in that said relative associated word similarity is calculated based on a cosine similarity of associated word collection vectors of a keyword in a period of time for comparison and associated word collection vectors of said keyword in a period of time of interest.

The 28th invention for solving the above-mentioned problem, in the above-mentioned 26th or 27th inventions, is characterized in that said step of evaluating a trend comprises step of evaluating a keyword having the smallest relative associated word similarity as a trend.

The 29th invention for solving the above-mentioned problem, in the above-mentioned 26th or 27th inventions, is characterized in that said step of evaluating a trend comprises step of evaluating a keyword having a relative associated word similarity smaller than a predetermined threshold value as a trend.

The 30th invention for solving the above-mentioned problem, in the above-mentioned 26th or 27th inventions, is characterized in that said step of evaluating a trend comprises step of accumulating a relative associated word similarity over a predetermined period of time to obtain a variance value thereof, and evaluating the relative associated word similarity corresponding to said variance value that exceeds a predetermined threshold value as a trend.

The 31st invention for solving the above-mentioned problem is characterized in that a trend evaluation method comprises the steps of: calculating a relative co-occurrence that is an indication indicating a change in a co-occurrence probability of a keyword and an associated word of this keyword; calculating a relative associated word similarity that is an indication of a degree of a change in a topic for said keyword; and calculating a trend score for representing trendiness of said keyword in a numerical form based on said calculated relative co-occurrence and said calculated the relative associated word similarity.

The 32nd invention for solving the above-mentioned problem, in the above-mentioned 31st invention, is characterized in that the trend evaluation method comprises step of evaluating a trend of said keyword based on said trend score.

The 33rd invention for solving the above-mentioned problem, in the above-mentioned 31st or 32nd inventions, is characterized in that said step of calculating a trend score comprises step of: calculating relative appearance that is an indication of a degree of rise of attention to a keyword, and; calculating a trend score for representing trendiness of said keyword in a numerical form based on said relative co-occurrence, said relative associated word similarity and the relative appearance.

The 34th invention for solving the above-mentioned problem, in any one of the above-mentioned 31st to 33rd inventions, is characterized in that said relative appearance is calculated from a ratio of an appearance probability of a keyword in a period of time of interest to an appearance probability of said keyword in a period of time for comparison.

The 35th invention for solving the above-mentioned problem, in any one of the above-mentioned 31st to 34th inventions, is characterized in that said step of calculating a trend score comprises step of calculating a trend score after weighting said relative co-occurrence, said relative associated word similarity or said relative appearance.

The 36th invention for solving the above-mentioned problem, in any one of the above-mentioned 31st to 35th inventions, is characterized in that a trend evaluation method comprises step of defining said relative co-occurrence, said relative associated word similarity or said relative appearance as a graphic and displaying it.

The 37th invention for solving the above-mentioned problem, in any one of the above-mentioned 31st to 36th inventions, is characterized in that a trend evaluation method recited comprises step of searching goods associated with said evaluated keyword from goods information and proposing them.

The 38th invention for solving the above-mentioned problem, in any one of the above-mentioned 31st to 37th inventions, is characterized in that a trend evaluation method comprises step of deciding cyclicity of a trend score of a keyword, and correcting the trend score in accordance with the cyclicity.

The 39th invention for solving the above-mentioned problem, in any one of the above-mentioned 31st to 38th inventions, is characterized in that a trend evaluation method comprises steps of: searching goods associated with said evaluated keyword from goods information; and searching a customer to whom these goods are to be recommended from customer information.

The 40th invention for solving the above-mentioned problem, in the above-mentioned 39th invention, is characterized in that a trend evaluation method comprises step of updating customer information based on a sales track record.

The 41st invention for solving the above-mentioned task, which is a program for a trend evaluation, is characterized in causing a computer to execute: relative co-occurrence calculating process of calculating a relative co-occurrence that is an indication indicating a change in a co-occurrence probability of a keyword and an associated word of this keyword; and trend evaluating process of evaluating a trend of said keyword based on the relative co-occurrence calculated by said relative co-occurrence calculating process.

The 42nd invention for solving the above-mentioned problem, in the above-mentioned 41st invention, is characterized in that said relative co-occurrence calculating process is process of calculating a relative co-occurrence from a ratio of a co-occurrence probability of the keyword and an associated word of this keyword in a period of time of interest to a co-occurrence probability of said keyword and an associated word of this keyword in a period of time for comparison.

The 43rd invention for solving the above-mentioned problem, in the above-mentioned 41st or 42nd inventions, is characterized in that said trend evaluating process is process of evaluating a combination of a keyword having the largest relative co-occurrence and an associated word of this keyword as a trend.

The 44th invention for solving the above-mentioned problem, in the above-mentioned 41st or 42nd inventions, is characterized in that said trend evaluating process is process of evaluating a combination of a keyword having a relative co-occurrence which exceeds a predetermined threshold value and an associated word of this keyword as a trend.

The 45th invention for solving the above-mentioned problem, in the above-mentioned 41st or 42nd inventions, is characterized in that said trend evaluating process is process of accumulating a relative co-occurrence within a predetermined period of time to obtain a variance value, and evaluating a combination of a keyword corresponding to said variance value which exceeds a predetermined threshold value and an associated word of this keyword as a trend.

The 44th invention for solving the above-mentioned problem, which is a program for a trend evaluation, is characterized in causing a computer to execute: relative associated word similarity calculating process of calculating a relative associated word similarity that is an indication of a degree of a change in a topic for a keyword; and trend evaluating process of evaluating a trend of said keyword based on the relative associated word similarity calculated by said relative associated word similarity calculating process.

The 47th invention for solving the above-mentioned problem, in the above-mentioned 46th invention, is characterized in that said relative associated word similarity calculating process is process of calculating a relative associated word similarity from a cosine similarity of associated word collection vectors of a keyword in a period of time for comparison and associated word collection vectors of said keyword in a period of time of interest.

The 48th invention for solving the above-mentioned problem, in the above-mentioned 46th or 47th inventions, is characterized in that said trend evaluating process is process of evaluating a keyword having the smallest relative associated word similarity as a trend.

The 49th invention for solving the above-mentioned problem, in the above-mentioned 46th or 47th inventions, is characterized in that said trend evaluating process is process of evaluating a keyword having a relative associated word similarity smaller than a predetermined threshold value as a trend.

The 50th invention for solving the above-mentioned problem, in the above-mentioned 46th or 47th inventions, is characterized in that said trend evaluating process is process of accumulating a relative associated word similarity over a predetermined period of time to obtain a variance value thereof, and evaluating the relative associated word similarity corresponding to said variance value that exceeds a predetermined threshold value as a trend.

The 51st invention for solving the above-mentioned problem, which is a program for a trend evaluation, is characterized in causing a computer to execute: relative co-occurrence calculating process of calculating a relative co-occurrence that is an indication indicating a change in a co-occurrence probability of a keyword and an associated word of this keyword; relative associated word similarity calculating process of calculating a relative associated word similarity that is an indication of a degree of a change in a topic for said keyword; and trend score calculating process of calculating a trend score for representing trendiness of said keyword in a numerical form based on the relative co-occurrence calculated by said relative co-occurrence calculating process and the relative associated word similarity calculated by said relative associated word similarity calculating process.

The 52nd invention for solving the above-mentioned problem, in the above-mentioned 51st invention, is characterized in that said program has trend evaluating process of evaluating a trend of said keyword based on said trend score.

The 53rd invention for solving the above-mentioned problem, in the above-mentioned 51st or 52nd inventions, is characterized in that said program has relative appearance calculating process of calculating relative appearance that is an indication of a degree of rise of attention to a keyword, and said trend score calculating process calculates a trend score for representing trendiness of said keyword in a numerical form based on the relative co-occurrence calculated by said relative co-occurrence calculating process, the relative associated word similarity calculated by said relative associated word similarity calculating process and the relative appearance calculated by said relative appearance calculating process.

The 54th invention for solving the above-mentioned problem, in any one of the above-mentioned 51st to 53rd inventions, is characterized in that said relative appearance calculating process is process of calculating relative appearance from a ratio of an appearance probability of a keyword in a period of time of interest to an appearance probability of said keyword in a period of time for comparison.

The 55th invention for solving the above-mentioned problem, in any one of the above-mentioned 51st to 54th inventions, is characterized in that said trend score calculating process calculates a trend score after weighting said relative co-occurrence, said relative associated word similarity or said relative appearance.

The 56th invention for solving the above-mentioned problem, in any one of the above-mentioned 51st to 55th inventions, is characterized in that said program has trend visualizing process of defining said relative co-occurrence, said relative associated word similarity or said relative appearance as a graphic and displaying it.

The 57th invention for solving the above-mentioned problem, in any one of the above-mentioned 51st to 56th inventions, is characterized in that said program has goods recommending process of searching goods associated with a keyword based on a result of said trend evaluating process from a goods information storing process in which information on goods is stored, and proposing them.

The 58th invention for solving the above-mentioned problem, in any one of the above-mentioned 51st to 57th inventions, is characterized in that said program has cyclicity deciding process of deciding cyclicity of a trend score of a keyword, and correcting the trend score in accordance with the cyclicity.

The 59th invention for solving the above-mentioned problem, in any one of the above-mentioned 52nd to 58th inventions, is characterized in that said program has goods recommending process of: searching goods associated with a keyword based on a result of said trend evaluating process from a goods information storing means in which information on goods is stored; searching a customer to whom these goods are to be recommended from a customer information storing means in which customer information on a customer is stored; and proposing them.

The 60th invention for solving the above-mentioned problem, in the above-mentioned 59th inventions, is characterized in that said program has update process of updating customer information in said customer information storing process based on a sales track record.

The present invention has a relative co-occurrence calculating means for calculating a relative co-occurrence indicating a change in a co-occurrence probability of a keyword and an associated word of this keyword; and/or a relative associated word similarity calculating means for calculating a relative associated word similarity that is an indication of a degree of a change in a topic for a keyword; and trend score calculating means for calculating a trend score for representing trendiness of said keyword in a numerical form based on the relative co-occurrence calculated by said relative co-occurrence calculating means and/or the relative associated word similarity calculated by said relative associated word similarity calculating means. When observation degree in itself as opposed to key word does not have change, and it is derogation aptitude change, the present invention detects the key word which there was as trend in key word or entirety of a topic that observation frequency to particular subtopic rose as for the present invention.

### EFFECTS OF THE INVENTION

A first effect of the present invention is that it is possible to detect a keyword whose topic undergoes a significant change as a trend irrespective of the degree of public attention to the keyword. This is because trendiness is decided taking account of a relative co-occurrence, which is a change in probability of co-occurrence with a specific keyword, and a relative associated word similarity, which is a degree of change in topic for a keyword.

A second effect of the present invention is that it is possible to easily grasp how a topic associated with a keyword changes. This is because a list of documents associated with a keyword, and graphs of relative appearance, relative co-occurrence, and relative relevance similarity can be displayed.

A third effect of the present invention is that operations of (1) deciding what is a trend, and (2) searching for associated goods fitting to the trend, can be automated, thereby improving efficiency in investigation of a promotion method for goods. This is because associated goods can be searched for presentation, along with associated documents and associated words for a keyword detected as a trend.

A fourth effect of the present invention is that it is possible to detect, as a trend at an earlier time, any keyword that is cyclically found as a trend even if a change so significant as to be detected as a trend does not appear yet in a period of time for analysis. This is because a period of time in which a trend score of a keyword cyclically rises is summed up from past trend detection data, and the trend score is corrected for a period of time for analysis.

A fifth effect of the present invention is that it is possible to decide to whom goods associated with a trend are to be recommended. This is because a keyword associated to a trend is used to search for customers having a great interest in the trend.

A sixth effect of the present invention is that it is possible to recommend trend-associated goods to more appropriate customers in accordance with an actual sales track record. This is because customer information is modified based on an actual sales track record to search for customers to whom goods are to be recommended.

### BRIEF DESCRIPTION OF THE DRAWINGS

FIG. 1 A block diagram showing a configuration of a first embodiment of the present invention.

FIG. 2 Exemplary data stored in a time series text storage section in the first embodiment of the present invention.

FIG. 3 Exemplary data stored in an associated word storage section in the first embodiment of the present invention.

FIG. 4 Exemplary data stored in a trend word storage section in the first embodiment of the present invention.

FIG. 5 A flow chart showing an operation of the first embodiment of the present invention.

FIG. 6 An example of a trend detection start window in the first embodiment of the present invention.

FIG. 7 An example of a trend detection result window in the first embodiment of the present invention.

FIG. 8 A block diagram showing a configuration of a second embodiment of the present invention.

FIG. 9 Exemplary goods data stored in a goods information storage section in the second embodiment of the present invention.

FIG. 10 Exemplary program data stored in the goods information storage section in the second embodiment of the present invention.

FIG. 11 A flow chart showing an operation of the second embodiment of the present invention.

FIG. 12 An example of recommendation of goods via a goods recommendation window in the second embodiment of the present invention.

FIG. 13 An example of recommendation of programs via a goods recommendation window in the second embodiment of the present invention.

FIG. 14 A block diagram showing a configuration of a third embodiment of the present invention.

FIG. 15 A flow chart showing an operation of the third embodiment of the present invention.

FIG. 16 Exemplary cyclicity data summed up by cyclicity deciding means in the third embodiment of the present invention.

FIG. 17 A block diagram showing a configuration of a fourth embodiment of the present invention.

FIG. 18 Exemplary data stored in a customer information storage section in the fourth embodiment of the present invention.

FIG. 19 A flow chart showing an operation of the fourth embodiment of the present invention.

FIG. 20 An example of a goods recommendation window in the fourth embodiment of the present invention.

FIG. 21 A block diagram showing a configuration of a fifth embodiment of the present invention.

FIG. 22 Exemplary data stored in a sales track record storage section in the fifth embodiment of the present invention.

FIG. 23 A flow chart showing an operation of the fifth embodiment of the present invention.

FIG. 24 A block diagram showing a configuration of sixth-tenth embodiments of the present invention.

FIG. 25 A block diagram of a trend evaluation apparatus 500 in the first embodiment of the present invention.

FIG. 26 Exemplary document data appended with time-stamp information in the first embodiment of the present invention.

FIG. 27 An example of a co-occurrence probability in the first embodiment of the present invention.

FIG. 28 An example of a relative co-occurrence in the first embodiment of the present invention.

FIG. 29 A block diagram of a trend evaluation apparatus 600 in the second embodiment of the present invention.

### EXPLANATION OF SYMBOLS

101-105 Trend evaluation apparatus
201 Input device
301 Output device
11 Time series text storage section
12 Associated word storage section
13 Trend word storage section
14 Goods information storage section
15 Customer information storage section
16 Sales track record storage section
21 Associated word extracting means
22 Relative appearance calculating means
23 Relative co-occurrence calculating means
24 Relative associated word similarity calculating means
25 Trend evaluating means
26 Trend visualizing means
27 Goods recommending means
28 Cyclicity deciding means
29 Second goods recommending means
30 Third goods recommending means

### BEST MODES FOR CARRYING OUT THE INVENTION

Now a first embodiment of the present invention will be described.

FIG. 25 is a block diagram of a trend evaluation apparatus 500 in the first embodiment of the present invention.

The trend evaluation apparatus 500 is configured of relative co-occurrence calculating means 501 for calculating a relative co-occurrence indicating a change in a co-occurrence probability of a specific keyword with an associated word of that keyword, and a trend evaluating means 502 for performing evaluation of a trend based on the calculated relative co-occurrence.

The relative co-occurrence calculating means 501 is supplied with a co-occurrence probability of a specific keyword with an associated word of that keyword in a period of time for comparison, and a co-occurrence probability of the specific keyword and the associated word of that keyword in a period of time of interest, to calculate a relative co-occurrence based thereon.

Now the co-occurrence probability input to the relative co-occurrence calculating means 501 will be described.

First, prior to calculation of a co-occurrence probability, extraction of a keyword is conducted. The extraction of a keyword is achieved by using a morphological analysis system from document data appended with time-stamp information as shown in FIG. 26 to extract a keyword. For example, an input statement, “Strong earthquake with seismic scale of 5 or more hit in the metropolitan area,” is divided using the morphological analysis system into morphemes “Strong/earthquake/with/seismic scale/of/5/or/more/hit/in/the/metropolitan/area.” While a statement divided into morphemes is provided in this example, many of morphological analysis systems have a function of appending part-of-speech information as well, resulting in “Strong(adj)/earthquake(n)/with(prep)/seismic scale(comp)/of(prep)/5(unknown)/or(conj)/more(n)/hit(v)/in(prep)/the(a)/metropolitan(adj)/area(n).” A given keyword is extracted from the thus-divided words, and a proportion that the extracted keyword occurs simultaneously with an associated word having a relation with that keyword is a co-occurrence probability. Specifically, a co-occurrence probability of an associated word J for a keyword K is defined by a proportion of the number of documents in which both the keyword K and associated word J occur constituted in the number of documents in which the keyword K occurs, or (in a case of web pages) a proportion of the number of sites in which both the keyword K and associated word J occur constituted in the number of sites in which the keyword K occur. For example, assuming that a number-of-sites-based co-occurrence probability is used, and if the number of sites in which “earthquake” occurs is 120 and the number of sites in which both “earthquake” and “seismic scale” occur is 72, the co-occurrence probability of “seismic scale” for “earthquake” is 72/120=60%. The thus-calculated co-occurrence probability is input to the relative co-occurrence calculating means 501.

Subsequently, calculation of the relative co-occurrence characterizing the present invention will be described. A relative co-occurrence is an indication representing a change in co-occurrence probability of a specific keyword and an associated word of that keyword. In other words, a relative co-occurrence of a keyword K and its associated word J is an indication representing the degree of rise of attention to a sub-topic (i.e., associated word) of the keyword K. Specifically, it can be calculated as a ratio of a co-occurrence probability Pt(J/K) of a keyword K and its associated word J in a period of time of interest to a co-occurrence probability Pb(J/K) of the keyword K and associated word J in a period of time for comparison, i.e., Pt(J/K)/Pb(J/K). For example, assuming that a co-occurrence probability of a keyword “earthquake” and its associated word “seismic scale” in a period of time for comparison, Jun. 1, 2005-Jun. 30, 2005, i.e., Pb(seismic scale/earthquake), is 50%, and a co-occurrence probability thereof in a period of time of interest, Jul. 21, 2005-Jul. 27, 2005, i.e., Pt(seismic scale/earthquake), is 60%, a relative co-occurrence “earthquake” and “seismic scale” is Pt(J/K)/Pb(J/K)=60/50=1.2. A larger relative co-occurrence implies a stronger association between a keyword and its associated word in a period of time of interest.

The trend evaluating means 502 evaluates a trend in a period of time of interest from the calculated relative co-occurrence. Methods of the evaluation include, as the simplest one, a method of evaluating as a trend a combination of a specific keyword and an associated word that has the largest relative co-occurrence among associated words for the specific keyword. For example, the method involves, when a relative co-occurrence of an associated word “women's” is the largest of those for a keyword “soccer” in a period of time of interest, evaluating that public attention is focused on “women's soccer.” Another method involves setting a given threshold, and evaluating a word exceeding the threshold as that on which public attention is focused. Still another method involves accumulating a relative co-occurrence of a specific keyword and its associated word over a given period of time, calculating a variance thereof, and evaluating a word having a variance value exceeding a certain threshold as that on which public attention is focused.

Yet still another method of trend evaluation involves calculating a co-occurrence probability day by day in the aforementioned period of time for comparison, determining its average Ps and variance V, calculating a co-occurrence probability day by day in the aforementioned period of time of interest in a similar manner, determining its average Px, and calculating a product F=H×G of a ratio of the averages H=(Px−Ps)/Ps and a reciprocal G of the variance G=1/V, for use of the product F as a relative co-occurrence. In this case, a larger product F implies a stronger association between a keyword and its associated word in the period of time of interest and a greater change in strength of association between the keyword and its associated word in the period of time of interest, so that it can be seen therefrom how sharply the relative co-occurrence changes as compared with ordinary times. Accordingly, a given threshold that seems to represent a normal change can be set to evaluate a specific keyword and its associated word corresponding to a product F (relative co-occurrence) exceeding the threshold as a trend.

Next, a particular operation of the thus-configured trend evaluation apparatus 500 will be described.

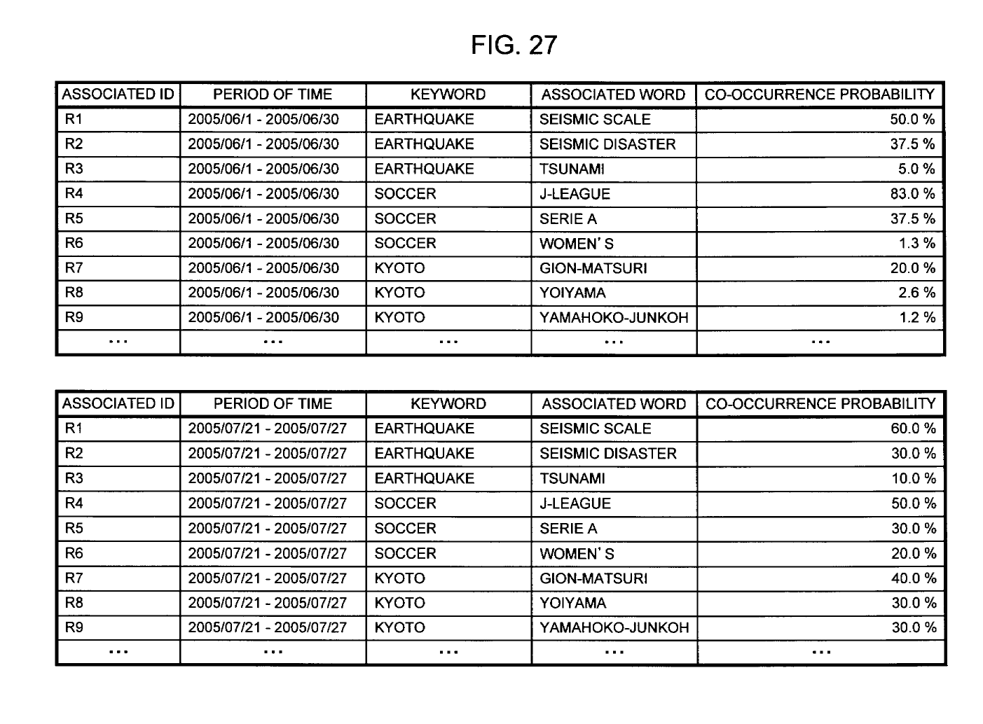

First, the relative co-occurrence calculating means 501 in the trend evaluation apparatus 500 is supplied with, as shown in FIG. 27, a co-occurrence probability in a period of time, Jun. 1, 2005-Jun. 30, 2005 and that in a period of time, Jul. 21, 2005-Jul. 27, 2005.

The relative co-occurrence calculating means 501 is assumed herein to calculate a relative co-occurrence with a period of time of interest from Jul. 21, 2005 through Jul. 27, 2005, and a period of time for comparison from Jun. 1, 2005 through Jun. 30, 2005.

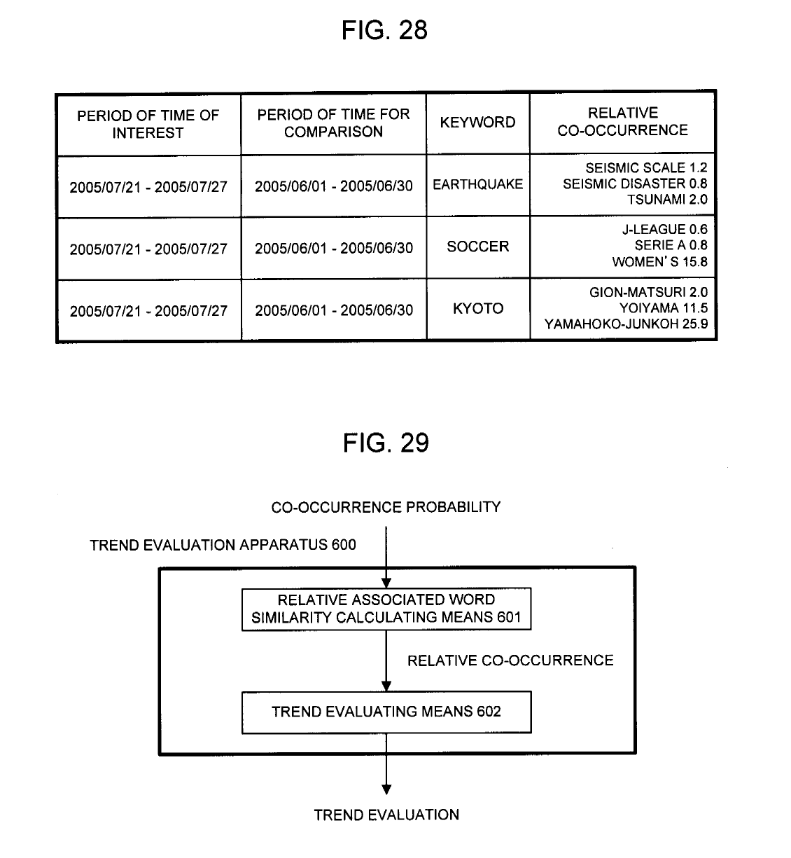

Then, the relative co-occurrence of an associated word “seismic scale” for a keyword “earthquake” is 60/50=1.2. The relative co-occurrence of an associated word “seismic disaster” for the keyword “earthquake” is 30/37.5=0.8. The relative co-occurrence of an associated word “tsunami” for the keyword “earthquake” is 10/5=2. Likewise, the relative co-occurrence of an associated word “J-league” for a keyword “soccer” is 50/83=0.6. The relative co-occurrence of an associated word “Serie A” for the keyword “soccer” is 30/37.5=0.8. The relative co-occurrence of an associated word “women's” for the keyword “soccer” is 20/1.3=15.8. Moreover, the relative co-occurrence of an associated word “Gion-Matsuri” for a keyword “Kyoto” is 40/20=2. The relative co-occurrence of an associated word “Yoiyama” for the keyword “Kyoto” is 30/2.6=11.5. The relative co-occurrence of an associated word “Yamahoko-Junkoh” for the keyword “Kyoto” is 30/1.2=25.9. Such results of the relative co-occurrence are shown in FIG. 28.

The trend evaluating means 502 performs evaluation of a trend with an input of the calculated relative co-occurrences as shown in FIG. 28. In this example, a word having the largest relative co-occurrence is selected for each keyword for evaluation as a word on which public attention is focused most for the keyword. In such evaluation, for the keyword “earthquake,” the associated word “tsunami” has a largest relative co-occurrence of 2, and it can be evaluated that attention is focused on “tsunami” in association with “earthquake.” For the keyword “soccer,” the associated word “women's” has a largest relative co-occurrence of 15.8, and it can be evaluated that attention is focused on “women's soccer” within “soccer.” For the keyword “Kyoto,” the associated word “Yamahoko-Junkoh” has a largest relative co-occurrence of 25.9, and it can be evaluated that attention is focused on “Yamahoko-Junkoh” within “Kyoto”.

Thus, since a trend is evaluated based on a relative co-occurrence representing a change in a co-occurrence probability of a specific keyword and an associated word of that keyword, it is possible to evaluate what is a trend for the keyword.

Now a second embodiment of the present invention will be described.

FIG. 29 is a block diagram of a trend evaluation apparatus 600 in the second embodiment of the present invention.

The trend evaluation apparatus 600 is configured of relative associated word similarity calculating means 601 for calculating a relative associated word similarity indicating a degree of change in topic for a keyword, and trend evaluating means 602 for performing evaluation of a trend based on the calculated relative associated word similarity.

The relative associated word similarity calculating means 601 is supplied with a specific keyword and an associated word of that keyword to calculate a relative associated word similarity based thereon.

Now the specific keyword and associated word of that keyword input to the relative associated word similarity calculating means 601 will be described.

First, as in the first embodiment, a morphological analysis system etc. is used to extract a keyword from document data, and a word occurring simultaneously with the keyword is defined as an associated word. However, if all words occurring simultaneously with the keyword are defined as associated words, auxiliary words and the like that are irrelevant by nature are undesirably covered; accordingly, the words may be limited, for example, to nouns, or to those having a co-occurrence probability as described above larger than a certain value. In this way, a specific keyword and an associated word that has a relation with that keyword in a period of time of interest and in a period of time for comparison are input to the relative associated word similarity calculating means 601.

Subsequently, calculation of the relative associated word similarity characterizing the present invention will be described. A relative associated word similarity is an indication of a degree of change in topic for a keyword. In particular, it can be calculated as a cosine similarity {Vb·Vt}/{|Vb|×|Vt|} of an associated word collection vector Vb for a keyword K in a period of time for comparison with an associated word collection vector Vt for the keyword K in a period of time of interest, where elements in the vectors Vb and Vt each represent whether an associated word is included or not by zero or one. For example, assuming that an associated word collection for a keyword “earthquake” in a period of time for comparison, Jun. 1, 2005-Jun. 30, 2005, contains “seismic scale,” “seismic disaster,” and “disaster,” and an associated word collection therefor in a period of time of interest, Jul. 21, 2005-Jul. 27, 2005, contains “seismic scale,” “seismic disaster,” and “tsunami,” elements of the vectors are assigned correspondingly with (seismic scale, seismic disaster, disaster, tsunami) in sequence, resulting in a relative associated word similarity of {(1,1,1,0)·(1,1,0,1)}/{|(1,1,1,0)|×|(1,1,0,1)|}={1+1+0+0}/3=0.67. A relative associated word similarity having a larger reciprocal thereof implies a more significant change between associated words for a keyword in a period of time for comparison and those in a period of time of interest.

While the relative associated word similarity is described as a cosine similarity herein, it is not so limited and a scalar product of or distance between vectors may be employed. Moreover, while elements in the vectors Vb, Vt are described as representing whether an associated word is contained or not by zero or one, it is not so limited and a co-occurrence probability of a keyword with each associated word may be employed. Furthermore, the vectors Vb, Vt each may be normalized to have a length of one, and they are not limited to those described in the embodiment.

The trend evaluating means 602 evaluates a trend in the period of time of interest from the calculated relative associated word similarity. Methods of the evaluation include, as the simplest one, a method of evaluating a keyword having the smallest relative associated word similarity (the largest reciprocal of the relative associated word similarity) as having a drastic change in associated words for the keyword in the period of time of interest, and as a hot trend. Another method involves setting a given threshold, and when a relative associated word similarity of a keyword becomes smaller than the threshold, evaluating the keyword having the relative associated word similarity as a trend. Still another method involves accumulating a relative associated word similarity over a given period of time, calculating a variance thereof, and evaluating a keyword having a relative associated word similarity whose variance value exceeds a certain threshold as a trend.

Yet still another method of trend evaluation that may be applied involves calculating a relative associated word similarity using a variance as with the aforementioned relative co-occurrence.

Thus, since a trend is evaluated based on a relative associated word similarity that is an indication of a degree of change in topic for a keyword, it is possible to evaluate a keyword whose topic undergoes a significant change as a trend, irrespective of the level of attention to the keyword.

Next, a third embodiment of the present invention will be described in detail with reference to the accompanying drawings.

The third embodiment is a concrete embodiment capable of more detailed trend evaluation, in addition to the first and second embodiments.

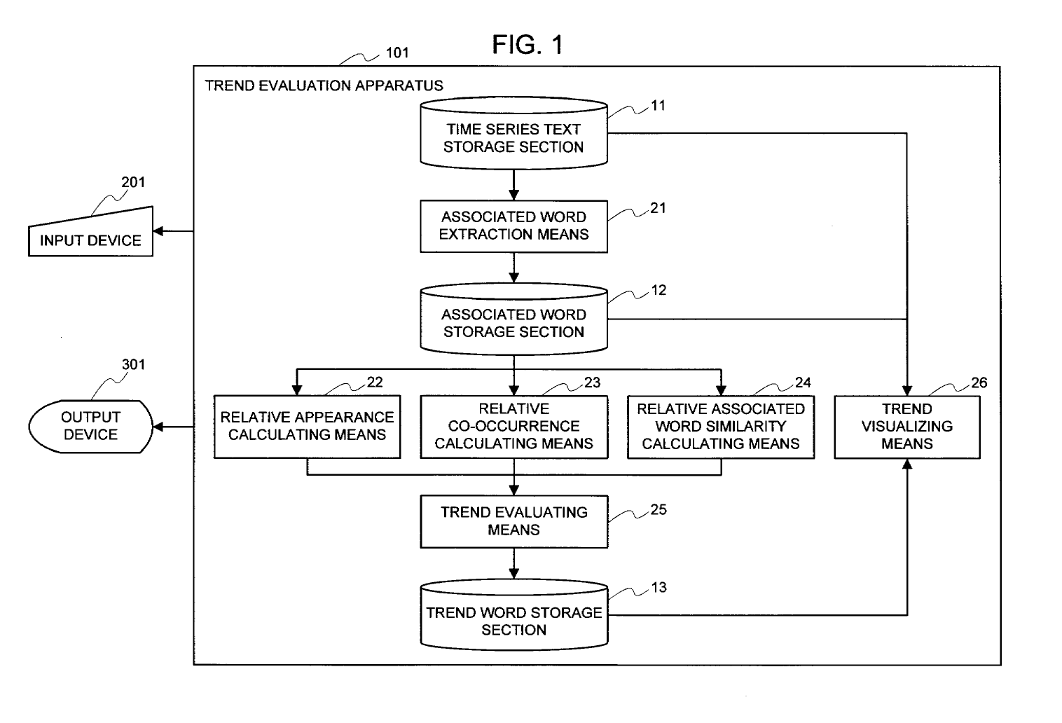

Referring to FIG. 1, the third embodiment of the present invention includes a trend evaluation apparatus 101, an input device 201 such as a keyboard, a mouse, and the like, and an output device 301 such as a display, a printer, and the like.

The trend evaluation apparatus 101 includes a time series text storage section 11, an associated word storage section 12 and a trend word storage section 13 for storing information; and associated word extracting means 21, relative appearance calculating means 22, relative co-occurrence calculating means 23, relative associated word similarity calculating means 24, trend evaluating means 25 and trend visualizing means 26 operated by program control.

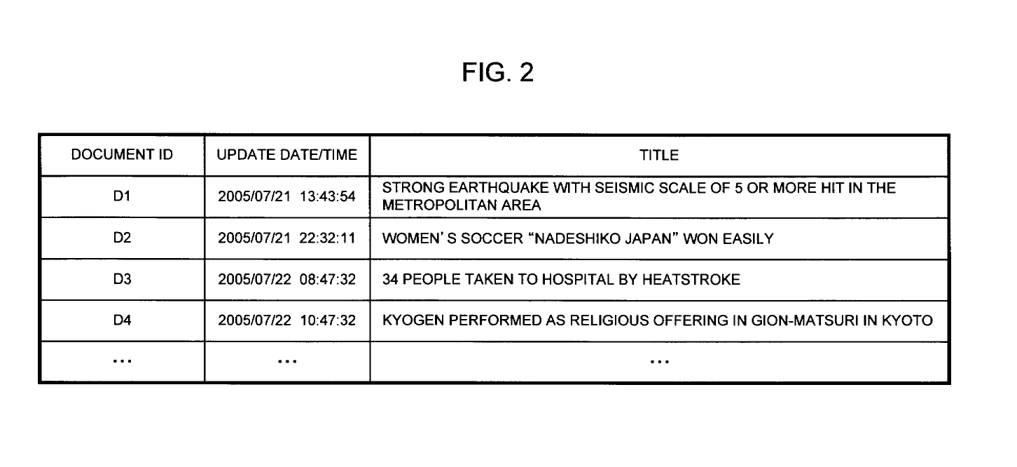

The time series text storage section 11 stores therein document data appended with time-stamp information. Exemplary document data stored in the time series text storage section 11 are shown in FIG. 2. In FIG. 2, the document data are stored with document ID, update date/time, and title. For example, it can be seen that a document with document ID of D1 has update date/time at Jul. 21, 2005, 13:43:54, which is entitled “Strong earthquake with seismic scale of 5 hit in the metropolitan area.” While an example in which document ID, update date/time, and title are stored as document data is taken here for simplification of explanation, information on a document including collection date/time, author, personal information on the author, text body, address, genre, etc. may also be stored. Moreover, temporal information such as the update date/time or collection date/time may include only year/month/date, and they are not limited to those described in this embodiment.

Moreover, documents that may be stored in the time series text storage section 11 may include those from several kinds of information sources, such as news stories, sports news, research papers, diaries, on-line forums, blogs, mailing lists, mail magazines, and the like. By limiting these information source to a specific field, a trend word can be extracted in the specific field. For example, by limiting the information source to news stories on the Iraq War, a trend in topics on the Iraq War can be detected. In addition to limitation on the information source, limitation on personal information on an author may be applied; for example, messages posted to an on-line forum may be limited to those by twentysomething women to evaluate a trend on which attention is focused lately by twentysomething women.

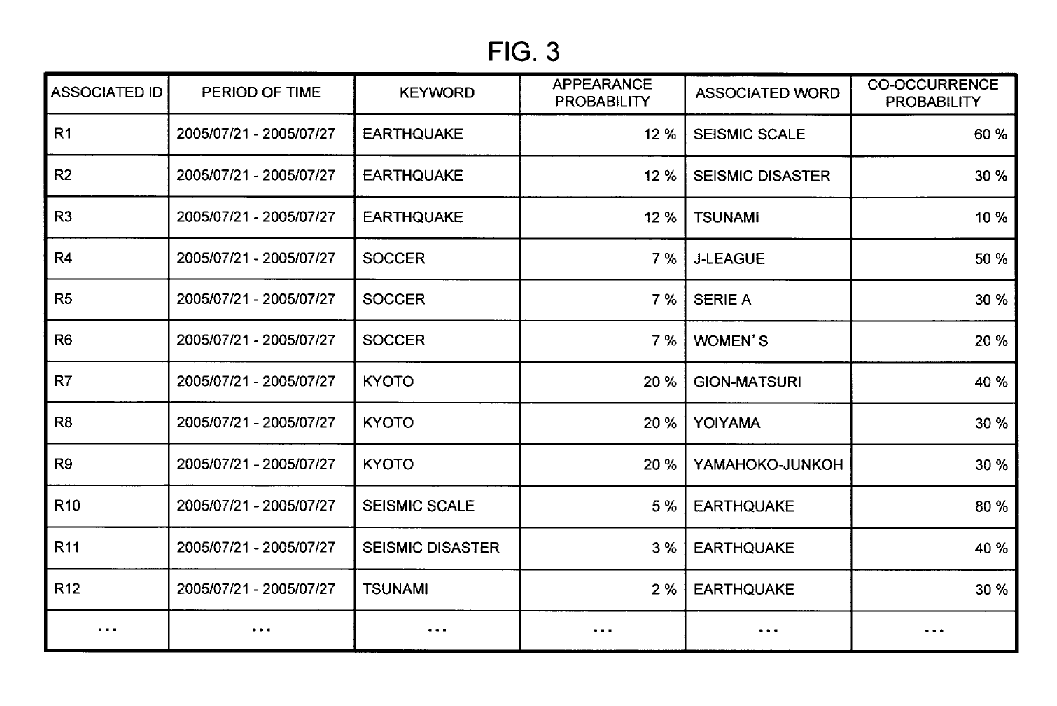

The associated word storage section 12 stores therein inter-word relevance data indicating with which word a certain word co-occurs in a specific period of time. Exemplary inter-word relevance data stored in the associated word storage section 12 are shown in FIG. 3. In FIG. 3, inter-word relevance data are stored with associated ID, a period of time, a keyword, an appearance probability, an associated word, and a co-occurrence probability. For example, referring to data having an associated ID of R1, it can be seen that an appearance probability of a keyword “earthquake” in a period of time, Jul. 21, 2005-Jul. 27, 2005, was 12%, and a co-occurrence probability thereof with an associated word “seismic scale” was 60%. The appearance probability of a keyword K as used herein is represented using a proportion of an appearance frequency of the keyword K constituted in the total appearance frequency of all keywords, or a proportion of the number of documents in which the keyword K appears constituted in the total number of documents, or (in a case of web pages) a proportion of the number of sites in which the keyword K appears constituted in the total number of sites.

For example, assuming that the number-of-sites-based appearance probability is used, and if the total number of sites is 1000 and the number of sites thereof in which a keyword “earthquake” appears is 120, the appearance probability for the keyword “earthquake” is 120/1000=12%. Moreover, the co-occurrence probability of an associated word J for a keyword K as used herein is represented using a proportion of the number of documents in which both the keyword K and associated word J appear constituted in the number of documents in which the keyword K appears, or (in a case of web pages) a proportion of the number of sites in which both the keyword K and associated word J appear constituted in the number of sites in which the keyword K appears. For example, assuming that a number-of-sites-based co-occurrence probability is used, and if the number of sites in which “earthquake” appears is 120 and the number of sites in which both “earthquake” and “seismic scale” appear is 72, the co-occurrence probability of “seismic scale” for “earthquake” is 72/120=60%.

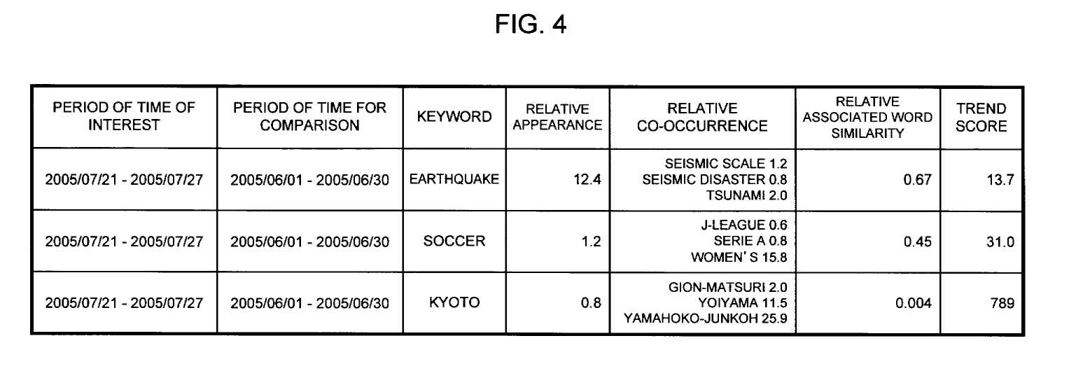

The trend word storage section 13 stores therein, for each keyword stored in the associated word storage section 12, a relative appearance, a relative co-occurrence, a relative associated word similarity and a trend score in a specific period of time of interest as compared with a period of time for comparison previous thereto. Exemplary data stored in the trend word storage section 13 are shown in FIG. 4. In FIG. 4, it can be seen that a relative appearance for a keyword “earthquake” in a period of time of interest, Jul. 21, 2005-Jul. 27, 2005, as compared with that in a period of time for comparison, Jun. 1, 2005-Jun. 30, 2005, is 12.4. It can also be seen that relative co-occurrences for associated words “seismic scale,” “seismic disaster” and “tsunami” are 1.2, 0.8 and 2.0, respectively. Moreover, it can be seen that the relative associated word similarity for the keyword “earthquake” is 0.67, and the trend score is 13.7.

As used herein, a relative appearance of a keyword K is an indication representing the degree of rise of attention to the keyword K. In particular, it can be calculated as a ratio of an appearance probability Pt(K) of the keyword K in a period of time of interest to an appearance probability Pb(K) of the keyword K in a period of time for comparison, i.e., Pt(K)/Pb(K). For example, assuming that an appearance probability for a keyword “earthquake” in a period of time for comparison, Jun. 1, 2005-Jun. 30, 2005, i.e., Pb(earthquake), is 0.97%, and an appearance probability thereof in a period of time of interest, Jul. 21, 2005-Jul. 27, 2005, i.e., Pt(earthquake), is 12%, a relative appearance is Pt(K)/Pb(K)=12/0.97=12.4. A larger value of the relative appearance implies a greater rise of attention in the period of time of interest. For example, in FIG. 4, it is expected that attention to the keyword “earthquake” is very high in the period of time of interest, Jul. 21, 2005-Jul. 27, 2005, whereas attention to the keyword “soccer” changes insignificantly, and attention to the keyword “Kyoto” shows a somewhat declining tendency.

As used herein, a relative co-occurrence of a keyword K and its associated word J is an indication representing the degree of rise of attention to a sub-topic for the keyword K. In particular, it can be calculated as a ratio of a co-occurrence probability Pt(J/K) of the keyword K and associated word J in a period of time of interest, to a co-occurrence probability Pb(J/K) of the keyword K and associated word J in a period of time for comparison, i.e., Pt(J/K)/Pb(J/K). For example, assuming that a co-occurrence probability for a keyword “earthquake” and its associated word “seismic scale” in a period of time for comparison, Jun. 1, 2005-Jun. 30, 2005, i.e., Pb(seismic scale/earthquake), is 50%, and a co-occurrence probability thereof in a period of time of interest, Jul. 21, 2005-Jul. 27, 2005, i.e., Pt(seismic scale/earthquake), is 60%, a relative co-occurrence of “earthquake” and “seismic scale” is Pt(J/K)/Pb(J/K)=60/50=1.2. A larger value of the relative co-occurrence implies a stronger association between the keyword and its associated word in the period of time of interest. For example, in FIG. 4, a keyword “soccer” is more strongly associated with “women's” in a period of time of interest, Jul. 21, 2005-Jul. 27, 2005, allowing us to expect that attention is focused on a sub-topic of “women's soccer” among “soccer” in the period of time.

As used herein, a relative associated word similarity for a keyword K is an indication representing the degree of change in topic for the keyword K. In particular, it can be calculated as a cosine similarity {Vb·Vt}/{|Vb|×|Vt|} of an associated word collection vector Vb for the keyword K in a period of time for comparison with an associated word collection vector Vt for the keyword K in a period of time of interest, where elements in the vectors Vb and Vt each represent whether an associated word is included or not by zero or one. For example, assuming that an associated word collection for a keyword “earthquake” in a period of time for comparison, Jun. 1, 2005-Jun. 30, 2005, contains “seismic scale,” “seismic disaster,” and “disaster,” and an associated word collection in a period of time of interest, Jul. 21, 2005-Jul. 27, 2005, contains “seismic scale,” “seismic disaster,” and “tsunami,” elements of the vector are assigned correspondingly with (seismic scale, seismic disaster, disaster, tsunami) in sequence, resulting in a relative associated word similarity of {(1,1,1,0)·(1,1,0,1)}/{|(1,1,1,0)|×|(1,1,0,1)|}={1+1+0+0}/3=0.67. A relative associated word similarity having a larger reciprocal thereof implies a more significant change between associated words for a keyword in a period of time for interest and those in a period of time of comparison. For example, in FIG. 4, most of associated words for a keyword “Kyoto” in a period of time for comparison, Jun. 1, 2005-Jun. 30, 2005, are changed over to other words in a period of time of interest, Jul. 21, 2005-Jul. 27, 2005, allowing us to expect that the topic on which attention is focused for “Kyoto” has changed.

While the relative associated word similarity is described as a cosine similarity herein, it is not so limited and a scalar product of or distance between vectors may be employed. Moreover, elements in the vectors Vb, Vt are described as representing whether associated words are contained or not by zero or one, it is not so limited and a co-occurrence probability of a keyword with each associated word may be employed. Furthermore, the vectors Vb, Vt each may be used after being normalized to have a length of one, and they are not limited to those described in the embodiment.

As used herein, a trend score for a keyword K refers to a value of trendiness of the keyword K represented in the numerical form. In particular, it is obtained by multiplying a relative appearance a1, a maximum value a2 of the relative co-occurrence, and a reciprocal a3 of the relative associated word similarity by respective weights w1, w2 and w3, and adding them. For example, assuming that a relative appearance a1 for a keyword “earthquake” is 12.4, a maximum value a2 of the relative co-occurrence is 2.0, and a reciprocal a3 of the relative associated word similarity is 1.5, and weights w1, w2 and w3 are 0.5, 1.5 and 3.0, respectively, the trend score for the keyword “earthquake” is w1*a1+w2*a2+w3*a3=0.5*12.4+1.5*2.0+3.0*1.5=13.7. While the trend score is a sum of a1, a2 and a3 multiplied by weights w1, w2 and w3 herein, it is not so limited and a method using a maximum value of w1*a1, w2*a2 and w3*a3 may be employed. Moreover, it is possible to employ a configuration in which the relative appearance is omitted from consideration by defining the weight w1 as zero and a combination of the relative co-occurrence and relative relevance similarity is taken into account, or a configuration in which the relative co-occurrence is omitted from consideration by defining the weight w2 as zero and a combination of the relative appearance and relative relevance similarity is taken into account, or a configuration in which the relative relevance similarity is omitted from consideration by defining the weight w3 as zero and a combination of the relative appearance and relative co-occurrence is taken into account.

Furthermore, the trend score calculated as described above may be applied with a weight. For example, the following configuration may be contemplated: a reciprocal of the variance V of the trend score is calculated as G=1/V, and G is defined as stability of change of a keyword. Then, an average Ps of the trend score in a period of time for comparison, and an average Px thereof in a period of time of interest are calculated to determine their ratio H=(Px−Ps)/Ps. A trend score (trendiness) F is then calculated as a product of the ratio H and stability G: i.e., F=G×H. A reason why the relative appearance is defined by (Px−Ps)/Ps, rather than Px/Ps, as described above, is as follows: when stability is to be incorporated into trend evaluation, it is not possible to make tendency estimation such that, for example, an upward tendency is estimated for Px/Ps>1, and a downward tendency is estimated for Px/Ps<1. By defining (Px−Ps)/Ps as relative appearance and a product of the relative appearance H and stability G as trend score (trendiness) F, it is possible to make tendency estimation of an upward tendency for F>0 and a downward tendency for F<0.

By thus taking the relative appearance, relative co-occurrence and relative relevance similarity into account, it is possible to detect as a trend not only words having increasing attention such as “earthquake”, but also words such as “soccer” and “women's,” for which attention to the word itself undergoes no change or rather shows a downward tendency but attention to its specific sub-topic is increased, or words such as “Kyoto,” for which the whole topic undergoes a change.

The associated word extracting means 21 reads time-stamped document data from the time series text storage section 11, calculates the appearance frequency of a keyword, and the co-occurrence probability thereof with its associated word in a period of time of interest and in a period of time for comparison specified via the input device 201, and stores the results in the associated word storage section 12. At that time, thresholds TH1 and TH2 for the appearance probability of a keyword are determined beforehand, and the keywords with an appearance probability equal to or greater than TH1 and less than TH2 are stored in the associated word storage section 12. For example, assuming that TH1=0% and TH2=100%, all words occurring in a document are stored as keywords. Alternatively, by specifying TH1=1% and TH2=90%, for example, words that rarely occur or on the contrary those that occur everywhere are prevented from being stored in the associated word storage section 12. Moreover, thresholds TH3 and TH4 for the co-occurrence probability of a keyword K and its associated word J are determined beforehand, and the associated words with a co-occurrence probability equal to or greater than TH3 and less than TH4 are stored in the associated word storage section 12. For example, assuming that TH3=0% and TH4=100%, all associated words J that occur simultaneously with a keyword K are stored as keywords. Alternatively, by specifying TH1=1% and TH2=90%, for example, associated words that scarcely co-occur or on the contrary those that always co-occur can be prevented from being stored in the associated word storage section 12.

The relative appearance calculating means 22 reads inter-word relevance data from the associated word storage section 12, calculates a ratio of the appearance probabilities in a period of time of interest and in a period of time for comparison specified via the input device 201 as relative appearance, and inputs it into the trend evaluating means 25.

The relative co-occurrence calculating means 23 reads inter-word relevance data from the associated word storage section 12, calculates a ratio of the co-occurrence probabilities of a keyword with its associated word in a period of time of interest and in a period of time for comparison specified via the input device 201 as relative co-occurrence, and inputs it into the trend evaluating means 25.

The relative associated word similarity calculating means 24 reads inter-word relevance data from the associated word storage section 12, calculates a cosine similarity of the associated word collection vectors in a period of time of interest and in a period of time for comparison specified via the input device 201 as relative associated word similarity, and inputs it into the trend evaluating means 25.

The trend evaluating means 25 calculates a trend score for each keyword based on the three values: the relative appearance supplied by the relative appearance calculating means 22, the relative co-occurrence supplied by the relative co-occurrence calculating means 23, and the relative associated word similarity supplied by the relative associated word similarity calculating means 24, multiplied by predetermined weights w1, w2 and w3, and stores the result in the trend word storage section 13. While in this embodiment, the trend evaluating means 25 stores all the calculated trend scores in the trend word storage section 13, the trend evaluating means 25 may be configured to store only those of the calculated trend scores that satisfy a given condition in the trend word storage section 13. Such a method for storing the trend score may be configured to set a given threshold beforehand, and store only information on a keyword corresponding to a trend score exceeding the threshold. Another method may be configured to calculate a variance of the trend score, and store only information on a keyword corresponding to a variance value exceeding a certain threshold.

The trend visualizing means 26 searches the time series text storage section 11 and associated word storage section 12 with a key of the keyword stored in the trend word storage section 13, and visualize associated documents, an appearance probability, and a temporal change in associated words for the keyword for presentation to a promoter via the output device 301.

Next, an operation of this embodiment will be described in detail with reference to FIGS. 1 and 2-7.

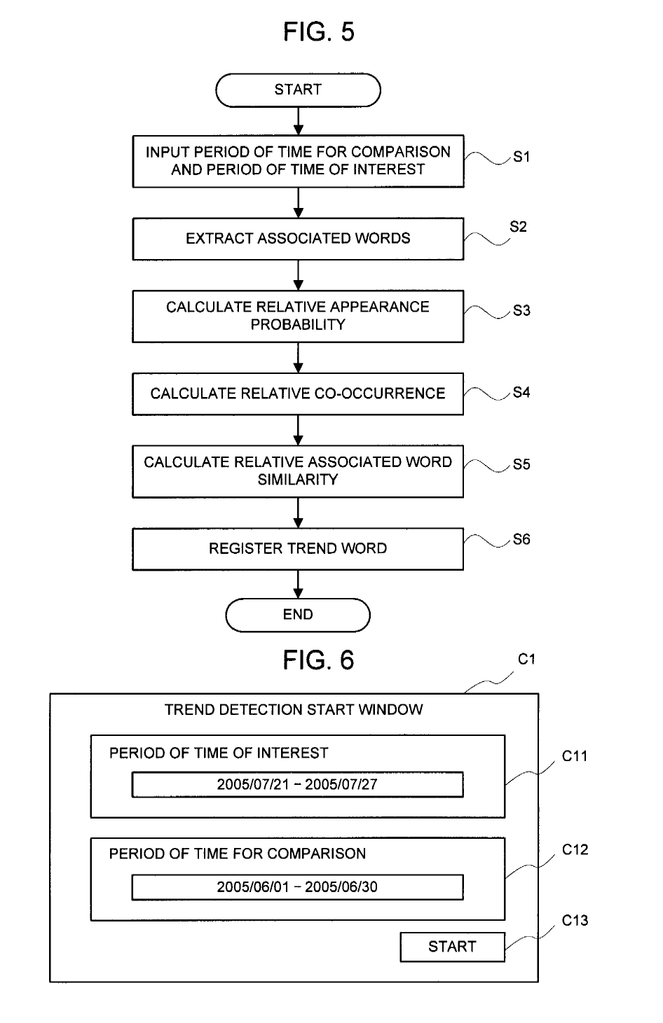

FIG. 5 is a flow chart showing an operation of the present invention.

First, a promoter inputs a period of time of interest and a period of time for comparison via the input device 201 (Step S1 in FIG. 5). An exemplary input window is shown in FIG. 6. A trend detection start window C1 in FIG. 6 is configured of a period-of-time-of-interest input field C11, a period-of-time-for-comparison input field C12, and a start button C13. In FIG. 6, the period of time of interest is specified as Jul. 21, 2005-Jul. 27, 2005, and the period of time for comparison is specified as Jun. 1, 2005-Jun. 30, 2005.

It should be noted that methods of specifying a period of time may include that of analyzing a short-term tendency by specifying a period of time of interest as only the day in question, and a period of time for comparison as one week back from yesterday. Another method may involve analyzing a long-term tendency by specifying a period of time of interest as a specific month (e.g., Jul. 1-Jul. 31, 2005), and a period of time for comparison as a half year before that (e.g., Jan. 1, 2005-Jun. 30, 2005). Still another method may involve analyzing a tendency as compared with the same period in the year before by specifying a period of time of interest as a specific month (e.g., Jul. 1-Jul. 31, 2005), and a period of time for comparison as the same month in the year before (Jul. 1, 2004-Jul. 31, 2004). Yet still another method may involve analyzing a tendency between the same days of the week by specifying a period of time of interest as only the day in question, and a period of time for comparison as the same days of the week in one preceding year. In this case, the period of time for comparison is discrete, and it can be input as dates delimited by commas in the period-of-time-for-comparison input field C12.

Upon clicking on of the start button C13 in the trend detection start window C1 in FIG. 6, the associated word extracting means 21 reads time-stamped document data from the time series text storage section 11, calculates an appearance frequency of a keyword and a co-occurrence probability thereof with its associated word in the specified period of time of interest and those in the specified period of time for comparison, and stores the results in the associated word storage section 12 (Step S2 in FIG. 5).

Next, the relative appearance calculating means 22 reads inter-word relevance data from the associated word storage section 12, calculates a ratio of the appearance probabilities in the period of time of interest and in the period of time for comparison specified via the input device 201 as relative appearance, and inputs it to the trend evaluating means 25 (Step S3 in FIG. 5).

Next, the relative co-occurrence calculating means 23 reads inter-word relevance data from the associated word storage section 12, calculates a ratio of the co-occurrence probabilities for a keyword and each associated word in the period of time of interest and in the period of time for comparison specified via the input device 201 as relative co-occurrence, and inputs it to the trend evaluating means 25 (Step S4 in FIG. 5).

Next, the relative associated word similarity calculating means 24 reads inter-word relevance data from the associated word storage section 12, calculates a cosine similarity for the associated word collection vectors in the period of time of interest and in the period of time for comparison specified via the input device 201 as relative associated word similarity, and inputs it to the trend evaluating means 25 (Step S5 in FIG. 5).

Next, the trend evaluating means 25 calculates a trend score for each keyword based on the three values: the relative appearance supplied by the relative appearance calculating means 22, the relative co-occurrence supplied by the relative co-occurrence calculating means 23, and the relative associated word similarity supplied by the relative associated word similarity calculating means 24, multiplied by predetermined weights w1, w2 and w3, and stores the results in the trend word storage section 13 (Step S6 in FIG. 5).

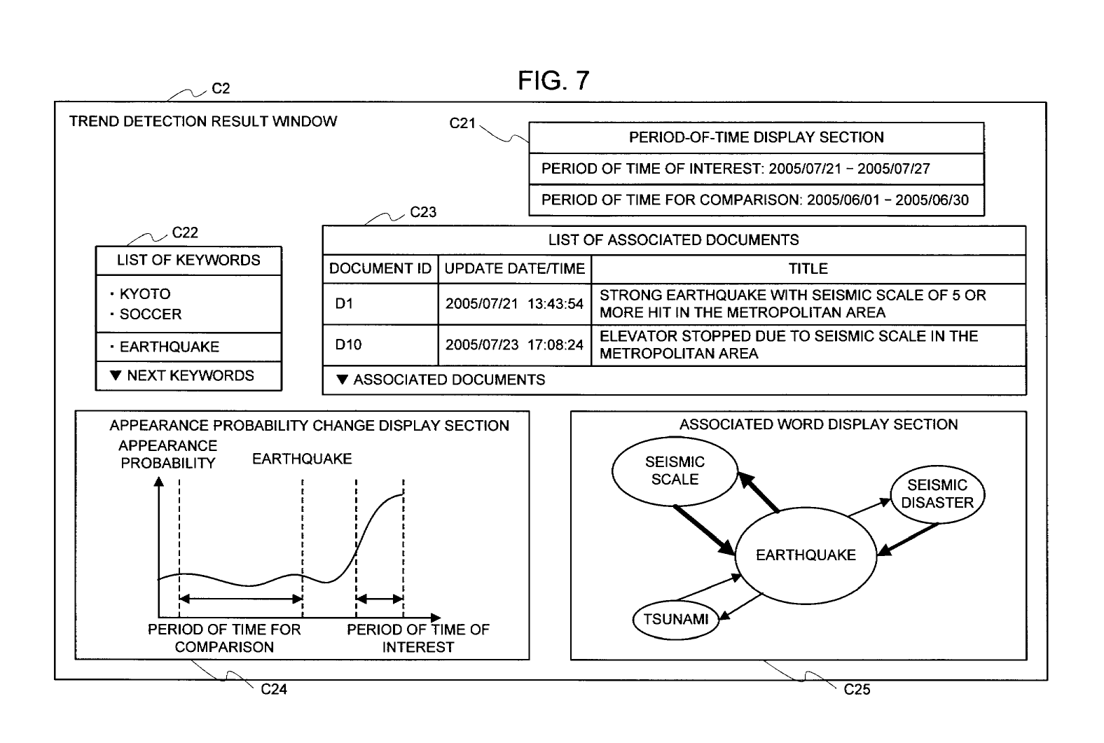

The trend visualizing means 26 is capable of displaying the results obtained at Steps S1-S6 via the output device 301, as shown in FIG. 7. A trend detection result window C2 in FIG. 7 is configured of a period-of-time display section C21, a keyword list C22, an associated document list C23, an appearance probability change display section C24, and an associated word display section C25.

In the period-of-time display section C21 are displayed a period of time of interest and a period of time for comparison specified by the promoter.

In the keyword list C22 is displayed a list of keywords stored in the trend word storage section 13. The arrangement of the keywords at that time may be any one of an alphabetical order, an order of the number of characters, an order of the trend score, and an order of the appearance probability, an order of the relative appearance, an order of the maximum value of the relative co-occurrence, and an order of the relative associated word similarity in a period of time of interest, etc. In a case that all keywords cannot be displayed in a single window, a link such as “▾NEXT KEYWORDS” may be displayed so that clicking on of the link causes next keywords to be displayed. In FIG. 7, a keyword “earthquake” is assumed to be in a selected state.

In the associated document list C23 is displayed a list of documents in a period of time of interest containing the keyword selected in the keyword list C22. The arrangement of the documents at that time may be any one of an order of the number of appearances of the keyword, an order of the update date/time, and the like. In a case that all documents cannot be displayed in a single window, a link such as “▾NEXT ASSOCIATED DOCUMENTS” may be displayed so that clicking on of the link causes next keywords to be displayed. Moreover, an address of a document may be displayed in place of the document ID so that designation of the address causes the document body to be displayed. In FIG. 7, documents containing a keyword “earthquake” in the title are displayed, including that having a document ID of D1 entitled “Strong earthquake with seismic scale of 5 or more hit in the metropolitan area,” and that having a document ID of D10 entitled “Elevator stopped due to earthquake in the metropolitan area.”

In the appearance probability change display section C24 is displayed a temporal change in an appearance probability of a keyword selected in the keyword list C22 in a period of time of interest and in a period of time for evaluation in a graphical format. Thus, the promoter can see a change in an appearance probability at a glance. In FIG. 7, the appearance probability for a keyword “earthquake” is rendered in a graphical format.

In the associated word display section C25 are displayed associated words relating to the keyword selected in the keyword list C22 in a network graph format. The network graph of associated words for a period of time of interest differs from that for a period of time for comparison, and the graphs can be switchably displayed using a link in the lower left of the associated word display section C25. The size of a node in the network graph represents the level of the appearance probability of a word in that period of time, and the thickness of an arc represents the level of the co-occurrence probability. In FIG. 7, data relating to a keyword “earthquake” stored in the associated word storage section 12 in FIG. 3 are displayed in a network format, in which the size of nodes is determined in proportion to appearance probabilities of keywords “earthquake,” “seismic scale,” “seismic disaster” and “tsunami” of 12%, 5%, 3% and 2%, respectively. Moreover, the co-occurrence probability of the associated word “tsunami” for the keyword “earthquake” is 10%, while that of the associated word “earthquake” for the keyword “seismic scale” is 80%, which results in the arc from “seismic scale” to “earthquake” is eight times thicker than that of the arc from “earthquake” to “tsunami.” Thus, a relationship between a keyword and its associated word in a certain period of time can be seen at a glance. Moreover, the graph in a period of time of interest and that in a period of time for comparison are switchably displayed, so that changes such as a change in size of nodes, a change in thickness of arcs, and a change in associated words around a keyword can be intuitively seen. In this case, the change in size of nodes corresponds to the relative appearance, the change in thickness of arcs corresponds to the relative co-occurrence, and the change in associated words around a keyword corresponds to the relative associated word similarity.

While the description has been made herein on a case in which “earthquake” is selected as a keyword in the keyword list C22 in the trend detection result window C2, once another keyword has been selected in the keyword list C22, the trend visualizing means 26 searches the time series text storage section 11 and associated word storage section 12 with a key of the selected keyword at that time, and renders associated documents, the appearance probability of the keyword, and a temporal change of its associated words in a graphic format.

Moreover, while the description has been made herein on an exemplary application in which a promoter who is a member of a business company such as a content provider or on-line shop uses the trend evaluation apparatus to grasp a trend and its associated documents and words, other applications may be additionally contemplated: for example, an application in which an analysis company that analyzes a trend is separately present, and the company sells the contents in the trend detection result window C2 in FIG. 7 to another business company as a report. Moreover, there may be still another application in which a business company that analyzes a trend, independent of any specific business companies such as a content provider or on-line shop, provides in its own way the trend detection result window C2 in FIG. 7 for public use to a large number of unspecified viewers; thus, the application is not limited to those described in this embodiment.

Next, effects of this embodiment will be described.

According to this embodiment, a trend score is calculated taking into account of the relative appearance, relative co-occurrence, and relative relevance similarity to determine trendiness of a keyword. Thus, it is possible to detect, as a trend, a keyword for which attention to the keyword itself undergoes no change or rather shows a downward tendency but attention to its specific sub-topic increases, or a keyword for which the whole topic undergoes a change.

Moreover, according to this embodiment, a list of documents associated with a keyword and graphs of the relative appearance, relative co-occurrence, and relative relevance similarity are displayed. Thus, it is possible to easily grasp how the topic associated with a keyword changes.

Next, a fourth embodiment of the present invention will be described in detail with reference to the accompanying drawings.

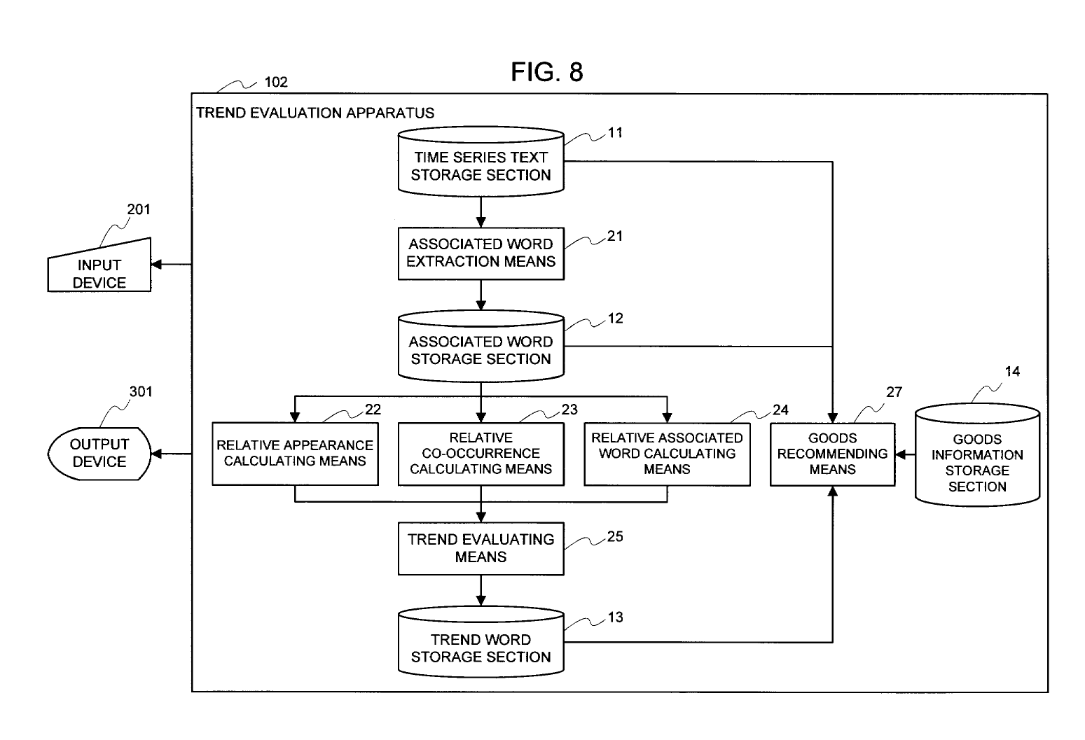

Referring to FIG. 8, the fourth embodiment of the present invention is different from the third embodiment shown in FIG. 1 in configuration, in which the trend visualizing means 26 is substituted with goods recommending means 27, and a goods information storage section 14 is added.

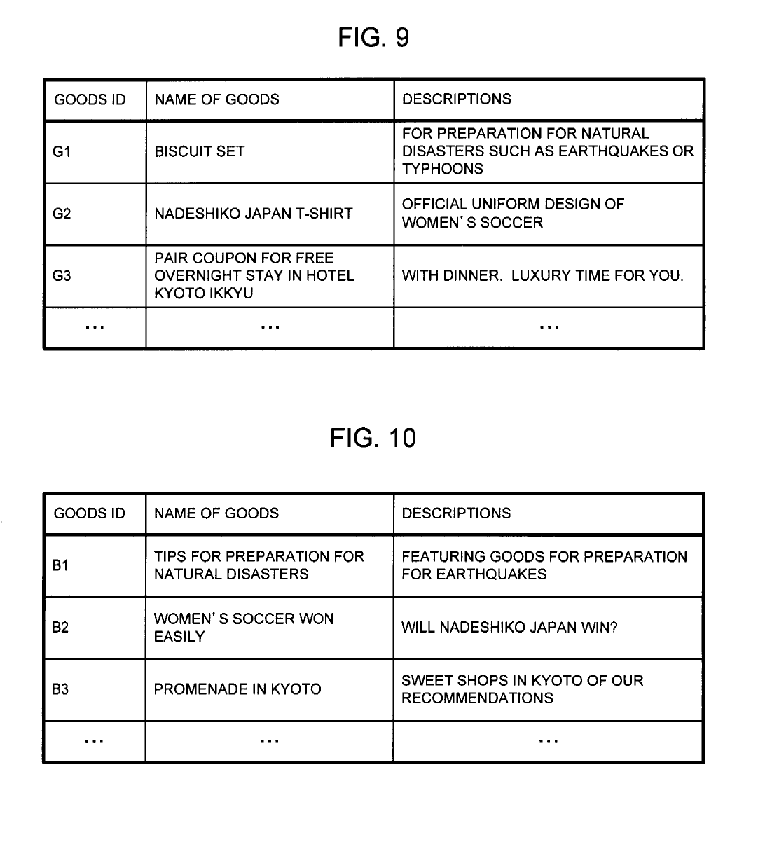

The goods information storage section 14 stores therein goods information. The goods information contains a name, descriptions, a catch phrase, images, a price, specification, terms of use, a contact address, an order form address, a purchase cost, profit, etc. of the goods. FIGS. 9 and 10 show exemplary goods information. FIGS. 9 and 10 show examples of goods information on goods defined as products and contents, respectively. In FIG. 9, goods ID, a name of goods, and descriptions of goods are stored, and in FIG. 10, program ID, a program name, and program descriptions are stored.

The goods recommending means 27 searches the time series text storage section 11, associated word storage section 12, and goods information storage section 14 with a key of the keyword stored in the trend word storage section 13, for presentation of associated documents and associated goods to the promoter via the output device 301.

An operation of this embodiment will be described in detail with reference to FIGS. 8-13.

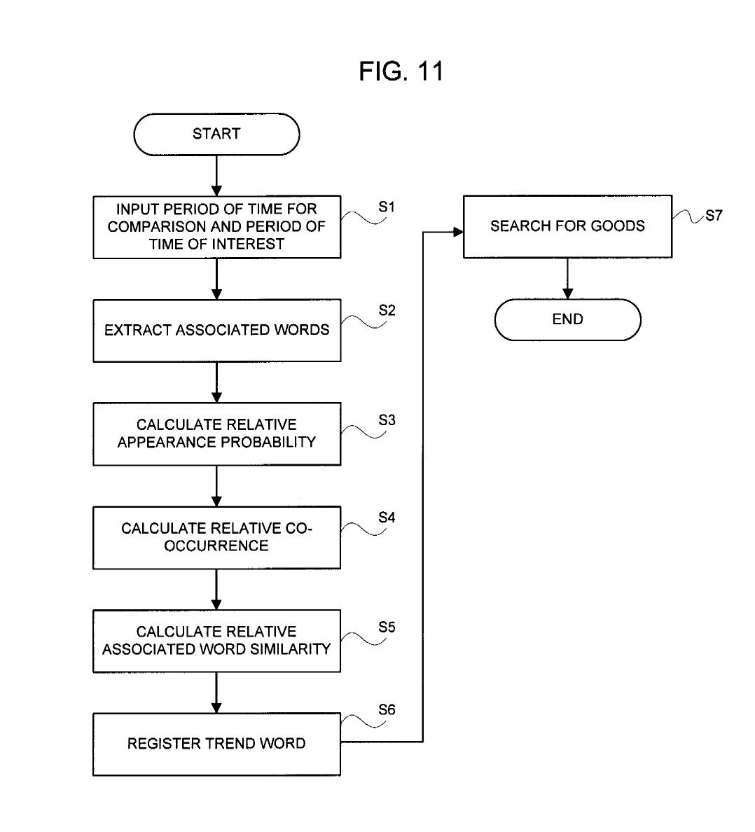

FIG. 11 is a flow chart depicting an operation of the fourth embodiment of the present invention.

Since the operations of the associated word extracting means 21, relative appearance calculating means 22, relative co-occurrence calculating means 23, relative associated word similarity calculating means 24, and trend evaluating means 25 at Steps S1-S6 in FIG. 11 are similar to those of the means 21-24 in the third embodiment shown in FIG. 5, description thereof will be omitted.

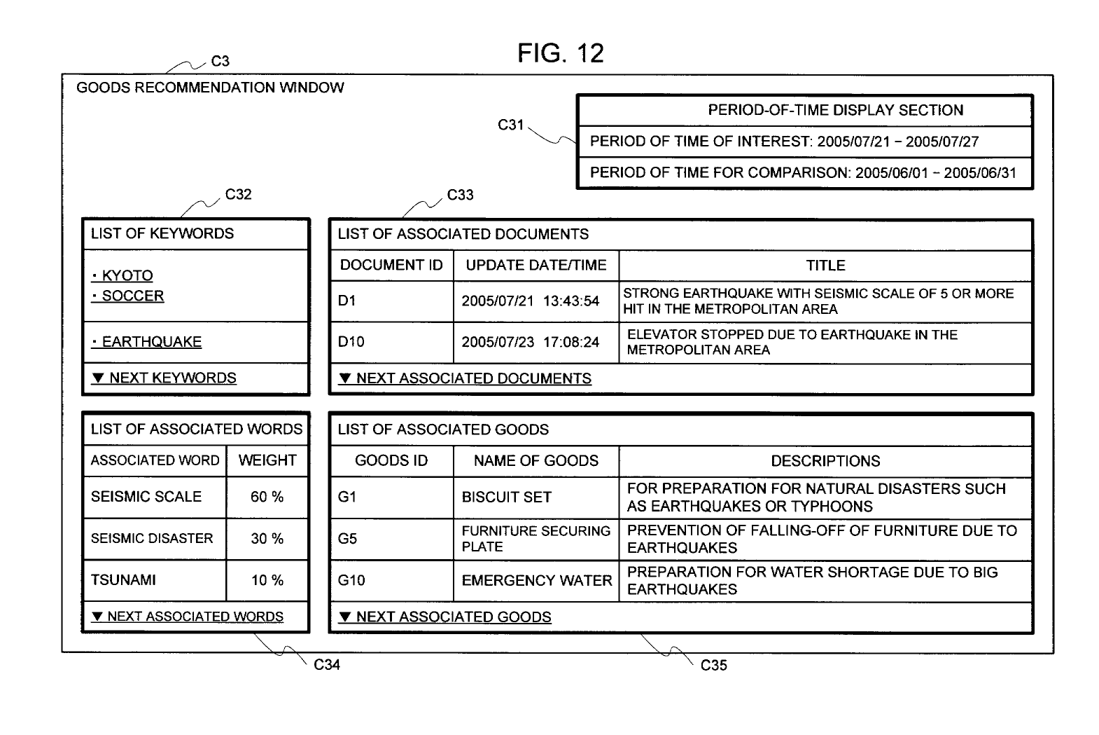

The goods recommending means 27 searches the time series text storage section 11, associated word storage section 12, and goods information storage section 14 with a key of the keyword in the trend word storage section 13 obtained at Steps S1-S6, for presentation of associated documents and associated goods to the promoter via the output device 301 in a goods recommendation window C3 as shown in FIG. 12 (Step S7 in FIG. 11). The goods recommendation window C3 is configured of a period-of-time display section C31, a keyword list C32, an associated document list C33, an associated word list C34, and an associated goods list C35. FIG. 12 shows an exemplary output in a case that goods information as shown in FIG. 9 is stored in the goods information storage section 14.

In the period-of-time display section C31 are displayed a period of time of interest and a period of time for comparison specified by the promoter.

In the keyword list C32 is displayed a list of keywords stored in the trend word storage section 13. The arrangement of the keywords at that time may be any one of an alphabetical order, an order of the number of characters, an order of the trend score, and an order of the appearance probability, an order of the relative appearance, an order of the maximum value of the relative co-occurrence, and an order of the relative associated word similarity in a period of time of interest, etc. In a case that all keywords cannot be displayed in a single window, a link such as “▾NEXT KEYWORDS” may be displayed so that clicking on of the link causes next keywords to be displayed. In FIG. 12, a keyword “earthquake” is assumed to be in a selected state.

In the associated document list C33 is displayed a list of documents in a period of time of interest containing the keyword selected in the keyword list C32. The arrangement of the documents at that time may be any one of an order of the number of appearances of the keyword, an order of the update date/time, and the like. In a case that all documents cannot be displayed in a single window, a link such as “▾NEXT ASSOCIATED DOCUMENTS” may be displayed so that clicking on of the link causes next keywords to be displayed. Moreover, an address of a document may be displayed in place of the document ID so that designation of the address causes the document body to be displayed. In FIG. 12, documents containing a keyword “earthquake” in the title are displayed, including that having a document ID of D1 entitled “Strong earthquake with seismic scale of 5 or more hit in the metropolitan area,” and that having a document ID of D10 entitled “Elevator stopped due to earthquake in the metropolitan area.”

In the associated word list C34 is displayed a list of associated words relating to the keyword selected in the keyword list C32. Here, the promoter is allowed to specify a weight for each associated word. The weight for an associated word is used to calculate importance of goods in searching for goods. An initial value for the weight of an associated word may be determined by any one of the methods including a method of setting all weights as the same value, and a method of employing the co-occurrence probability with a keyword.

In the associated goods list C35 is displayed a list of associated goods relating to the keyword selected in the keyword list C32. The associated goods herein refer to goods having the name of the goods or description containing the keyword selected in the keyword list C32 or its associated word. The arrangement of the goods at that time may be any one of an order of the number of appearances of the keyword, an order of the total number of appearances of an associated word multiplied by the weight specified in the associated word list C34, an order of the price of the goods, an order of the profit of the goods, and the like. In a case that all goods cannot be displayed in a single window, a link such as “▾NEXT GOODS” may be displayed so that clicking on of the link causes next goods to be displayed. In FIG. 12, goods having a name of goods or descriptions containing the keyword “earthquake” are displayed, including “biscuit set,” “furniture securing plate,” and “emergency water.”

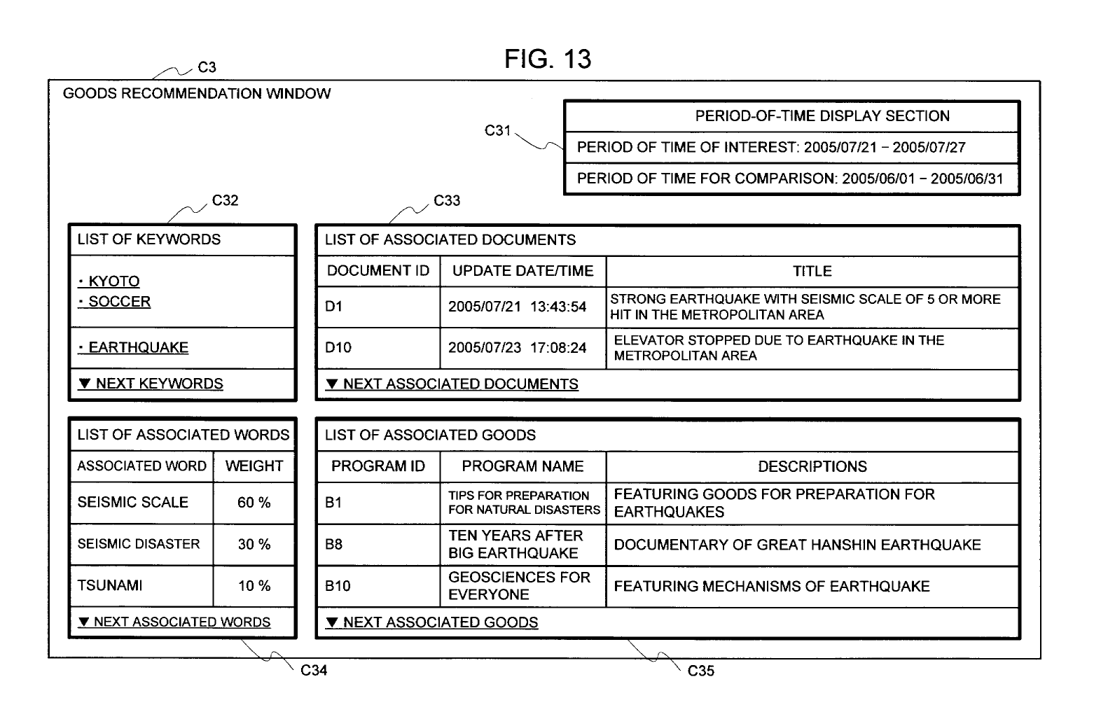

While an exemplary output in which goods information as shown in FIG. 9 are stored in the goods information storage section 14 has been described in FIG. 12, recommendation may be made in a similar manner when program information as shown in FIG. 10 are stored in the goods information storage section 14. An example of the goods recommendation window in this case is shown in FIG. 13.

In FIG. 13, “earthquake” is in a selected state as a keyword in the keyword list C32, and the same data as those in FIG. 12 are displayed in the associated document list C33 and associated word list C34. However, programs having the program name or description containing the keyword “earthquake” are displayed in the associated goods list C35, i.e., “Tips for Preparation for Natural Disasters” “Ten Years after Big Earthquake,” and “Geosciences for Everyone.” In this manner, the goods recommending means 27 is capable of recommending goods in association with a trend in a similar method regardless of field. While examples having separate fields of goods information as in FIGS. 9 and 10 have been described herein, it is possible to store both goods information and program information in the goods information storage section 14 to recommend both products and programs as goods in association with to a trend.

While the description has been made herein on a case in which “earthquake” is selected as a keyword in the keyword list C32 in the goods recommendation window C3, once another keyword has been selected in the keyword list C32, the goods recommending means 27 searches the time series text storage section 11, associated word storage section 12, and goods information storage section 14 with a key of the selected keyword to output associated documents or goods.

Moreover, while the description has been made herein on an exemplary application in which a promoter who is a member of a business company such as a content provider or on-line shop uses the trend evaluation apparatus to grasp a trend and its associated documents, associated words, and associated goods, other applications may be additionally contemplated: for example, an application in which an analysis company that analyzes a trend is separately present, the company sells the information stored in the time series text storage section 11, associated word storage section 12, and trend word storage section 13 to the promoter as a report, and the promoter uses the goods recommending means 27 to search for associated goods for the trend. Moreover, there may be still another application in which a promoter provides goods information to an analysis company, and the analysis company makes a report summarizing the contents displayed in the goods recommendation window C3 in FIG. 12 and sells the report to the promoter. Furthermore, there may be yet another application in which an analysis company is provided with goods information from one or more promoters, and the analysis company itself performs promotion of goods associated with a trend and charges the promoters with a sales commission. In addition, there may be yet still another application in which an analysis company is provided with goods information from one or more promoters, the analysis company provides a report summarizing the contents displayed in the goods recommendation window C3 in FIG. 12 to a sales agent, and the sales agent charges the promoters with a sales commission, and the analysis company charges the sales agent and/or promoters with an information fee.

This trend evaluation apparatus may also be applied to goods presentation in the Internet. For example, when a plurality of kinds of items are to be presented although a display area in one page is limited, as in on-line auction, a seller of the on-line auction desires to present the items that are trendy on a top page. Then, this trend evaluation apparatus is configured to store information on auction selling items (keywords, selling item description, etc.) in the goods information storage section 14, causing the goods recommending means 27 to search for selling items associated with a keyword evaluated as a trend, and presenting the selling items on a top page. It should be noted that the number of selectable selling items is defined depending upon a display area for selling items.

Next, an effect of this embodiment will be described.

According to this embodiment, the goods recommending means 27 searches for associated goods along with associated documents and associated words for a keyword detected as a trend for presentation. Thus, operations of (1) deciding what is a trend, and (2) searching for associated goods fitting to the trend, can be automated, thereby improving efficiency in investigation of a promotion method for goods.

Next, a fifth embodiment of the present invention will be described in detail with reference to the accompanying drawings.

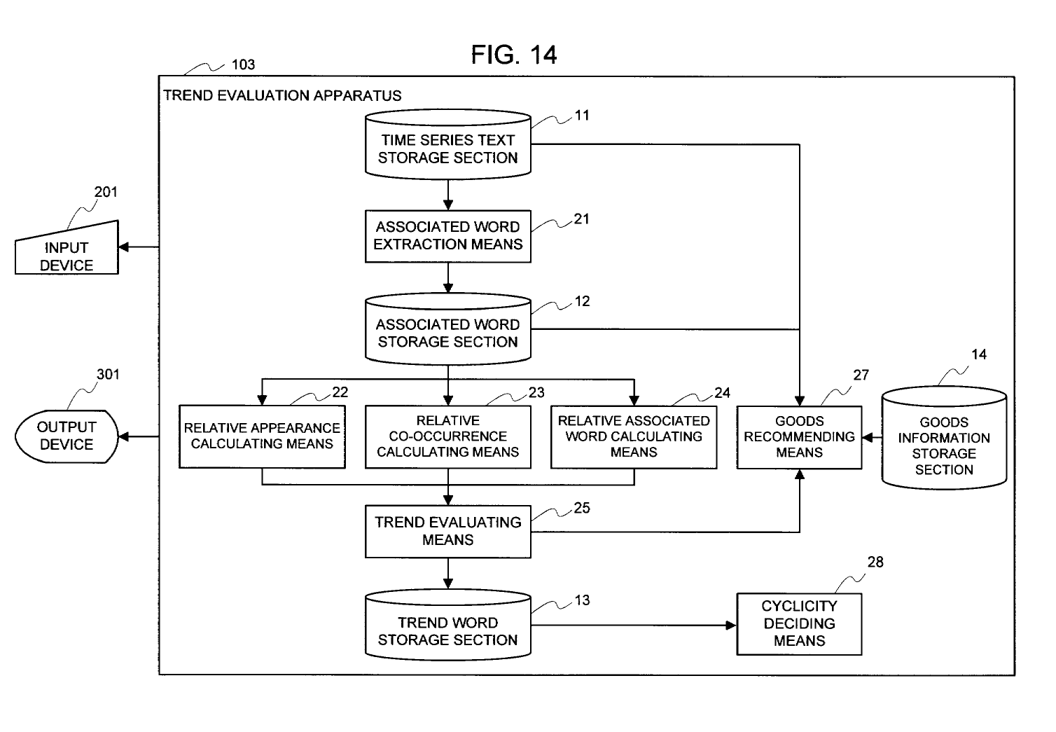

Referring to FIG. 14, the fifth embodiment of the present invention is different from the fourth embodiment shown in FIG. 8 in configuration, in which cyclicity deciding means 28 is added.

The cyclicity deciding means 28 continually monitors keywords registered in the trend word storage section 13, detects those whose trend score periodically rises, and corrects the trend score according thereto.

An operation of this embodiment will be described in detail with reference to FIGS. 14-16.

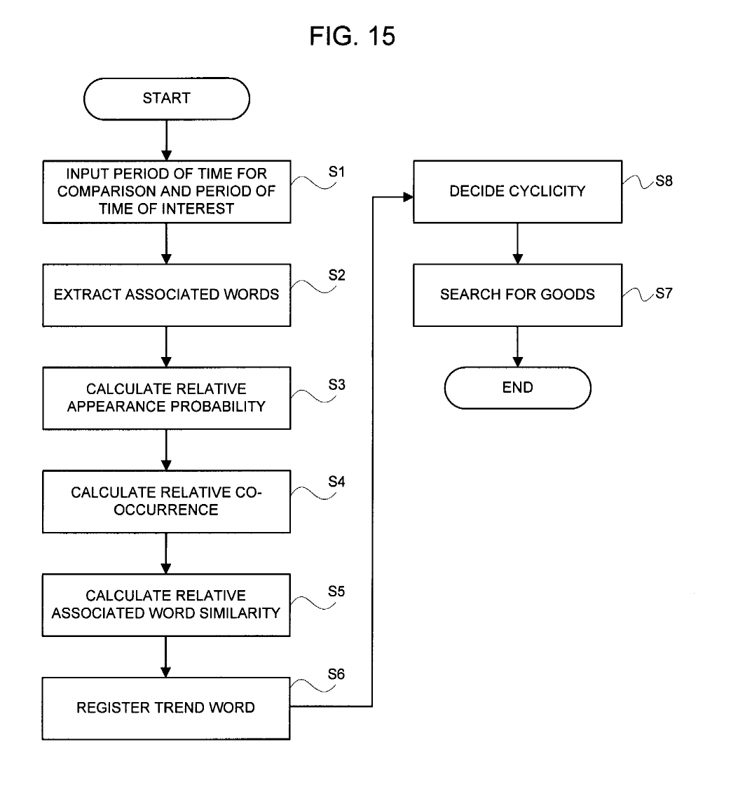

FIG. 15 is a flow chart depicting an operation of the fifth embodiment of the present invention.

Since the operations of the associated word extracting means 21, relative appearance calculating means 22, relative co-occurrence calculating means 23, relative associated word similarity calculating means 24, trend evaluating means 25, and goods recommending means 26 at Steps S1-S7 in FIG. 15 are similar to those of the means 21-26 in the fourth embodiment shown in FIG. 8, description thereof will be omitted.

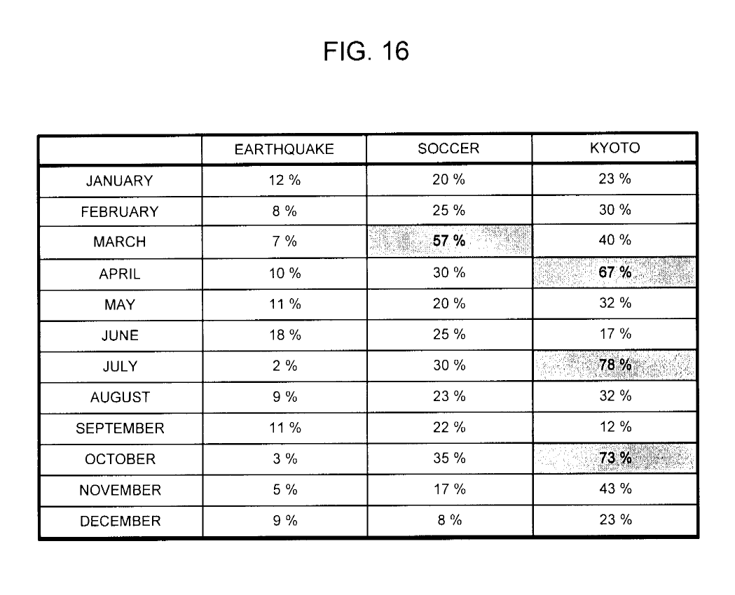

The cyclicity deciding means 28 sums up, for each keyword registered in the trend word storage section 13, the probability of the trend score exceeding a threshold TH5 in the past Y years at intervals of a certain period of time (Step S8 in FIG. 15). FIG. 16 shows an example of monthly summing-up. For example, assuming that Y=5 and TH5=100 in FIG. 16, it can be seen that the keyword “earthquake” has a proportion of the trend score exceeding 100 in January being 12% in the past five years. It is considered that a more cyclical trend tends to give a higher value of this probability. For example, consider a period of time in FIG. 16 in which the probability is greater than 50%, and it can be seen that the trend score for “soccer” tends to cyclically rise in March every year, and the trend score for “Kyoto” tends to cyclically rise in April, July and October every year. Moreover, the cyclicity deciding means 28 adds a corrective value to the trend score for each keyword in a period of time for analysis. The corrective value may be obtained by a method involving, for example, adding, to the trend score in the period of time for analysis, the trend score multiplied by a probability of the trend score exceeding the threshold TH5 in the past. For example, assuming that a current period of time for analysis is Jul. 21, 2005-Jul. 27, 2005, the contents in the trend word storage section 13 are as shown in FIG. 4, and cyclicity in the past is as shown in FIG. 16, the trend score for the keyword “earthquake” is corrected to 13.7+13.7*0.02=13.97. The trend score for the keyword “soccer” is corrected to 31.0+31.0*0.3=40.3. The trend score for the keyword “Kyoto” is corrected to 789+789*0.78=1404. In this manner, the trend score is corrected to a higher value for a keyword that tends to be a trend with cyclicity. Thus, any keyword that is cyclically found as a trend can be detected as a trend at an earlier time even if a change so significant as to be detected as a trend does not appear yet in a period of time for analysis.

While a month has been taken here as an example of an interval of a certain period of time in FIG. 16, other summing-up methods may be contemplated: for example, summing-up for an x-th week in every month, or a certain day of every month or a certain day of every week, and the method is not limited to those described in this embodiment.

Next, an effect of this embodiment will be described.

According to this embodiment, the cyclicity deciding means 28 sums up a period of time in which a trend score of a keyword cyclically rises from past data in the trend word storage section 13, and corrects the trend score in the period of time for analysis. Thus, any keyword that is cyclically found as a trend can be detected as a trend at an earlier time even if a change so significant as to be detected as a trend does not appear yet in a period of time for analysis.

Next, a sixth embodiment of the present invention will be described in detail with reference to the accompanying drawings.

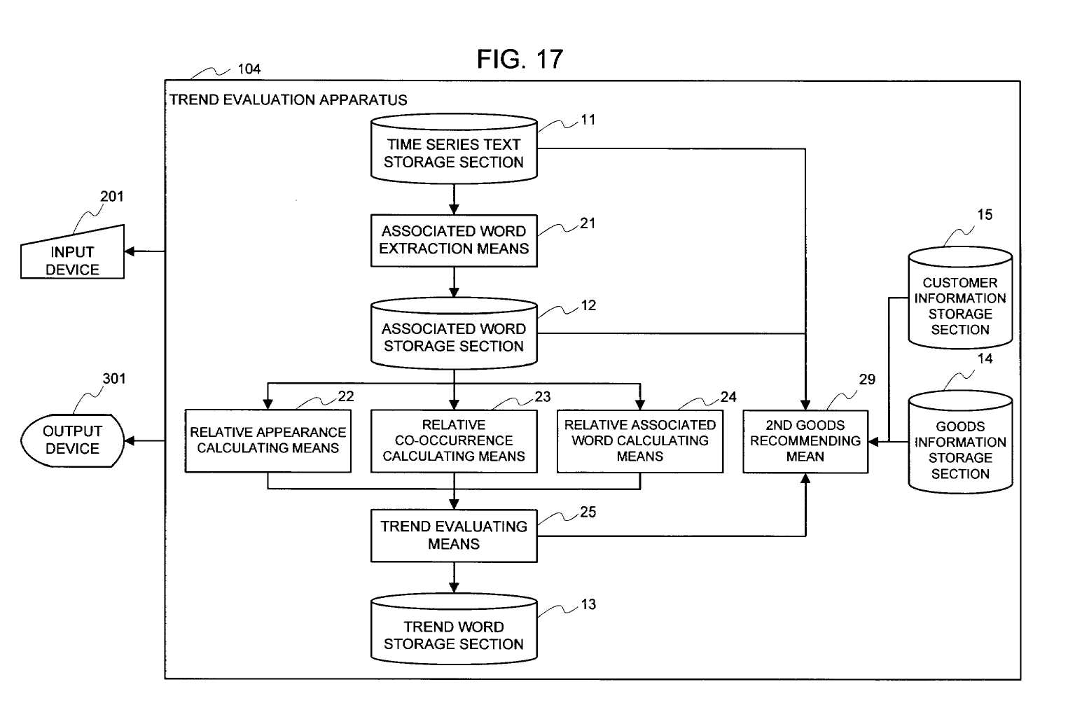

Referring to FIG. 17, the sixth embodiment of the present invention is different from the fourth embodiment in FIG. 8 in configuration, in which the goods recommending means 27 is substituted with second goods recommending means 29, and a customer information storage section 15 is added.

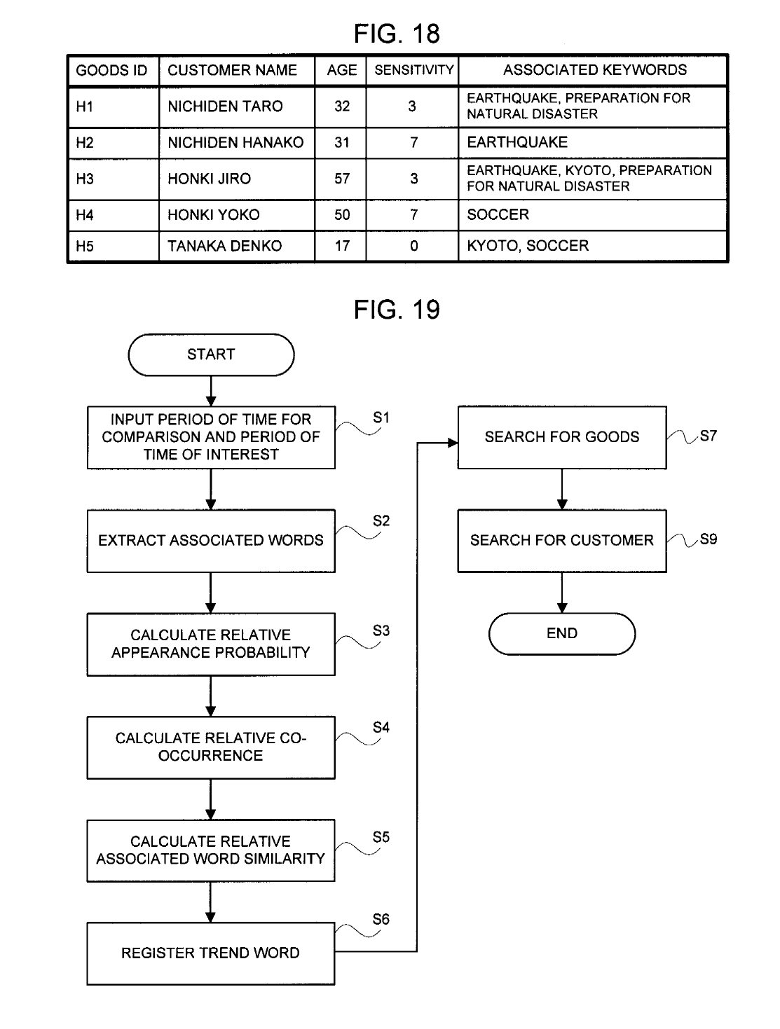

The customer information storage section 15 stores therein customer information. The customer information contains customer's name, age, address, phone number, occupation, annual income, hobby, past transaction, sensitivity, keyword of interest, etc. FIG. 18 shows exemplary customer information. In FIG. 18, customer ID, customer name, age, sensitivity, and keyword of interest are stored. As used herein, sensitivity refers to a numerical expression in terms of days representing how long time lag it takes to react to a trend. Methods of determining sensitivity may include a method of a direct check by a questionnaire to a customer when he/she has registered customer information. For example, a question “I am sensitive to a trend,” and three alternative answers “Yes,” “No” and “Neither” may be provided, and respective answers may be assigned with sensitivities of 0, 7 and 3. The number of alternative answers is not limited to three, and it may be five or may be determined by a customer directly answering the number of days corresponding to sensitivity. As used herein, the keyword of interest refers to a keyword associated to a topic that a customer is interested in. Methods of determining a keyword of interest may include a method of a direct check by a questionnaire to a customer when he/she has registered customer information. For example, a question “What keyword are you interested in lately?” is provided and a customer answers the question in a free format, and the answer may be determined as keyword of interest as is.

The second goods recommending means 29 searches the time series text storage section 11, associated word storage section 12, goods information storage section 14, and customer information storage section 15 with a key of the keyword stored in the trend word storage section 13, for presentation of associated documents, associated goods, and customers to whom goods are to be recommended, to the promoter via the output device 301.

An operation of this embodiment will be described in detail with reference to FIGS. 17-20.

FIG. 19 is a flow chart depicting an operation of the sixth embodiment of the present invention.

Since the operations of the associated word extracting means 21, relative appearance calculating means 22, relative co-occurrence calculating means 23, relative associated word similarity calculating means 24, and trend evaluating means 25 at Steps S1-S6 in FIG. 19 are similar to those of the means 21-25 in the fourth embodiment shown in FIG. 8, description thereof will be omitted.

The second goods recommending means 29 searches the time series text storage section 11, associated word storage section 12, and goods information storage section 14 with a key of the keyword in the trend word storage section 13 obtained at Steps S1-S6, to obtain lists of associated documents and associated goods (Step S7 in FIG. 19).

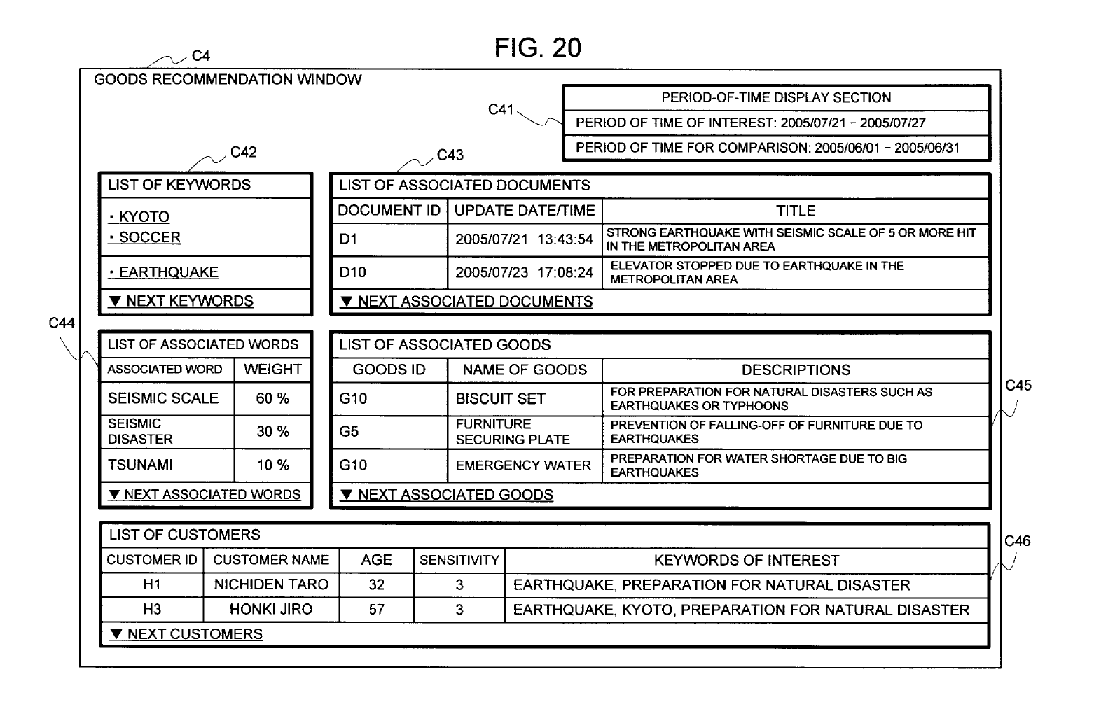

Next, the second goods recommending means 29 searches the customer information storage section 15 with a key of the keyword in the trend word storage section 13, for presentation of associated documents, associated goods, and appropriate customer to whom recommendation is to be addressed, to the promoter via the output device 301 in a goods recommendation window C4 as shown in FIG. 20 (Step S9 in FIG. 19). The goods recommendation window C4 is configured of a period-of-time display section C41, a keyword list C42, an associated document list C43, an associated word list C44, an associated goods list C45, and a customer list C46. Since the information displayed in C41-C45 in FIG. 20 are similar to those displayed in C31-C35 in the goods recommendation window C3 in the fourth embodiment shown in FIG. 12, description thereof will be omitted.

In the customer list C46 is displayed a list of customers who have registered a keyword selected in the keyword list C42 as a keyword of interest. The arrangement of the customer information at that time may be any one of an alphabetical order of the customer name, an order of the sensitivity, an order of the age, an order of the annual income, an order of the past transaction, and the like. In a case that all customer information cannot be displayed in a single window, a link such as “▾NEXT CUSTOMERS” may be displayed so that clicking on of the link causes next customer information to be displayed. In FIG. 20, customers whose keywords of interest include a keyword “earthquake”, and whose sensitivity is a smaller number of days, i.e., “NICHIDEN Taro” and “HONKI Jiro” are displayed. Thus, the promoter can decide to whom goods associated with a trend is to be recommended.

While the description has been made herein on an exemplary application in which a promoter who is a member of a business company such as a content provider or on-line shop uses the trend evaluation apparatus to grasp a trend and its associated documents, associated words, associated goods, and customers to whom goods are to be recommended, other applications may be additionally contemplated: for example, an application in which an analysis company that analyzes a trend is separately present, the company sells the contents in the time series text storage section 11, associated word storage section 12, and trend word storage section 13 to the promoter as a report, and the promoter uses the second goods recommending means 29 to search for a customer to whom associated goods for a trend are to be recommended. Moreover, there may be still another application in which a promoter provides goods information and customer information to an analysis company, and the analysis company makes a report summarizing the contents displayed in the goods recommendation window C4 in FIG. 20 and sells the report to the promoter. Furthermore, there may be yet another application in which an analysis company is provided with goods information and customer information from one or more promoters, and the analysis company itself performs promotion of goods associated with a trend and charges the promoters with a sales commission. In addition, there may be yet still another application in which an analysis company is provided with goods information and customer information from one or more companies, the analysis company provides a report summarizing the contents displayed in the goods recommendation window C3 in FIG. 12 to a sales agent, the sales agent charges the promoters with a sales commission, and the analysis company charges the sales agent and/or promoters with an information fee.

Next, an effect of this embodiment will be described.

According to this embodiment, the second goods recommending means 29 searches the customer information storage section 15 with a key of the keyword stored in the trend word storage section 13. Thus, it is possible to decide to whom goods associated with a trend are to be recommended.

Next, a seventh embodiment of the present invention will be described in detail with reference to the accompanying drawings.

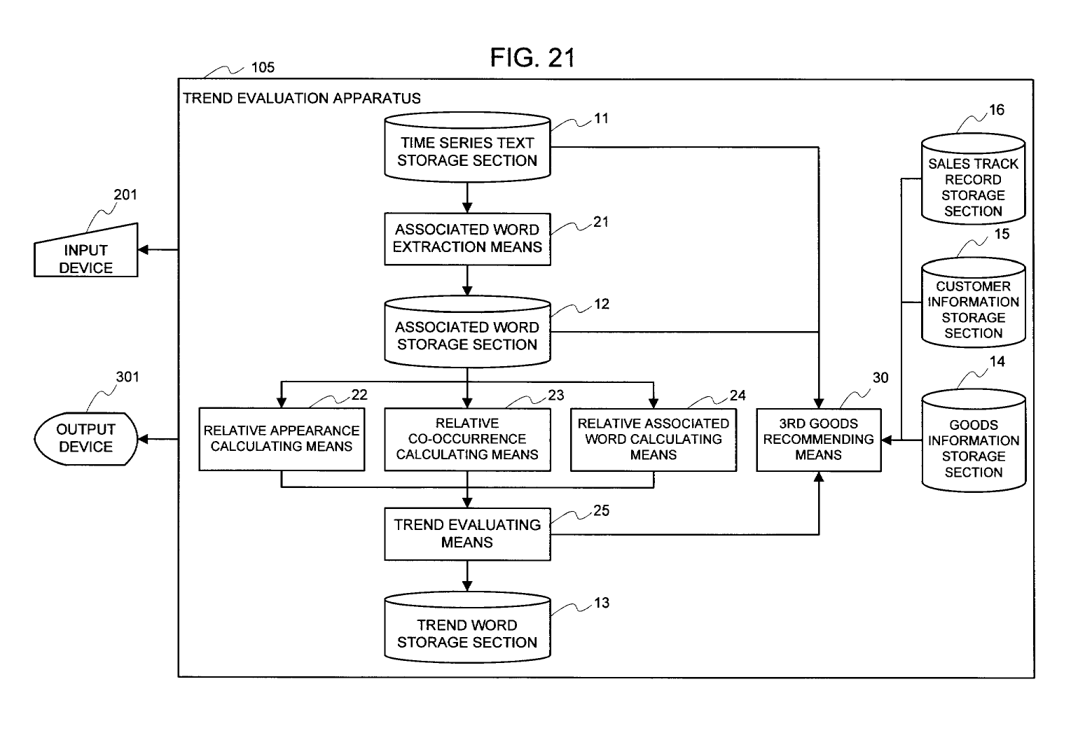

Referring to FIG. 21, the seventh embodiment of the present invention is different from the sixth embodiment shown in FIG. 17 in configuration, in which the second goods recommending means 29 is substituted with third goods recommending means 30, and a sales track record storage section 16 is added.

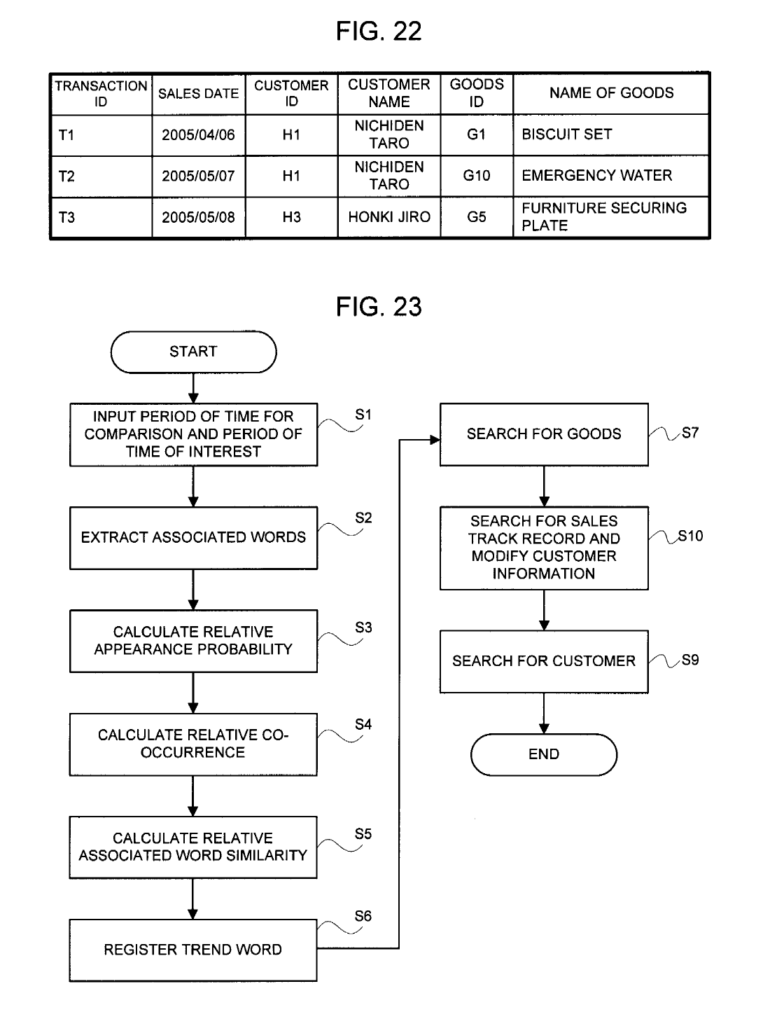

The sales track record storage section 16 stores therein sales track record information. The sales track information contains sales date, ID and name of a purchaser, goods ID and a name of goods, the number of items sold, a sales price, etc. FIG. 22 shows exemplary sales track information. In FIG. 22, the sales date, ID and name of a purchaser, and goods ID and a name of goods are stored.

The third goods recommending means 30 searches the time series text storage section 11, associated word storage section 12, goods information storage section 14, customer information storage section 15, and sales track record storage section 16 with a key of the keyword stored in the trend word storage section 13, for presentation of associated documents, associated goods, and customers to whom goods are to be recommended, to the promoter via the output device 301.

An operation of this embodiment will be described in detail with reference to FIGS. 21-23.

FIG. 23 is a flow chart depicting an operation of the seventh embodiment of the present invention.

Since the operations of the associated word extracting means 21, relative appearance calculating means 22, relative co-occurrence calculating means 23, relative associated word similarity calculating means 24, and trend evaluating means 25 at Steps S1-S6 in FIG. 23 are similar to those of the means 21-25 in the fourth embodiment shown in FIG. 8, description thereof will be omitted.

The third goods recommending means 30 searches the time series text storage section 11, associated word storage section 12, and goods information storage section 14 with a key of the keyword in the trend word storage section 13 obtained at Steps S1-S6 to obtain lists of associated documents and associated goods (Step S7 in FIG. 23).

Next, the third goods recommending means 30 searches the sales track record storage section 16 with a key of the customer ID stored in the customer information storage section 15 to obtain a list representing which customer purchased which goods in the past, and at the same time, searches the goods information storage section 14 with a key of the goods ID in the sales track record to obtain information indicating what description is given to the goods. The thus-found the name of goods and descriptions are divided using morphological analysis, for example, and adds the customers and keywords of their respective purchased goods to the keywords of interest stored in the customer information storage section 15. Moreover, by searching the trend word storage section 13 with a key of the keyword relating to the goods, how many days has passed when the goods are purchased from the last rise of the trend score thereof is calculated, and the number of days is replaced for the sensitivity value stored in the customer information storage section 15 (Step S10 in FIG. 23).

Next, the third goods recommending means 30 searches the modified customer information storage section 15 with a key of the keyword in the trend word storage section 13, for presentation of the associated documents, associated goods, and appropriate customer to whom recommendation is to be addressed, to the promoter via the output device 301 in the goods recommendation window C4 as shown in FIG. 20 (Step S9 in FIG. 23). Thus, trend-associated goods can be recommended to a more appropriate customer in accordance with an actual sales track record.

Next, an effect of this embodiment will be described.

According to this embodiment, the third goods recommending means 30 modifies customer information based on an actual sales track record and finds out customers to whom goods are to be recommended. Thus, it is possible to recommend trend-associated goods to a more appropriate customer in accordance with an actual sales track record.

Next, an eighth embodiment of the present invention will be described in detail with reference to the accompanying drawings.

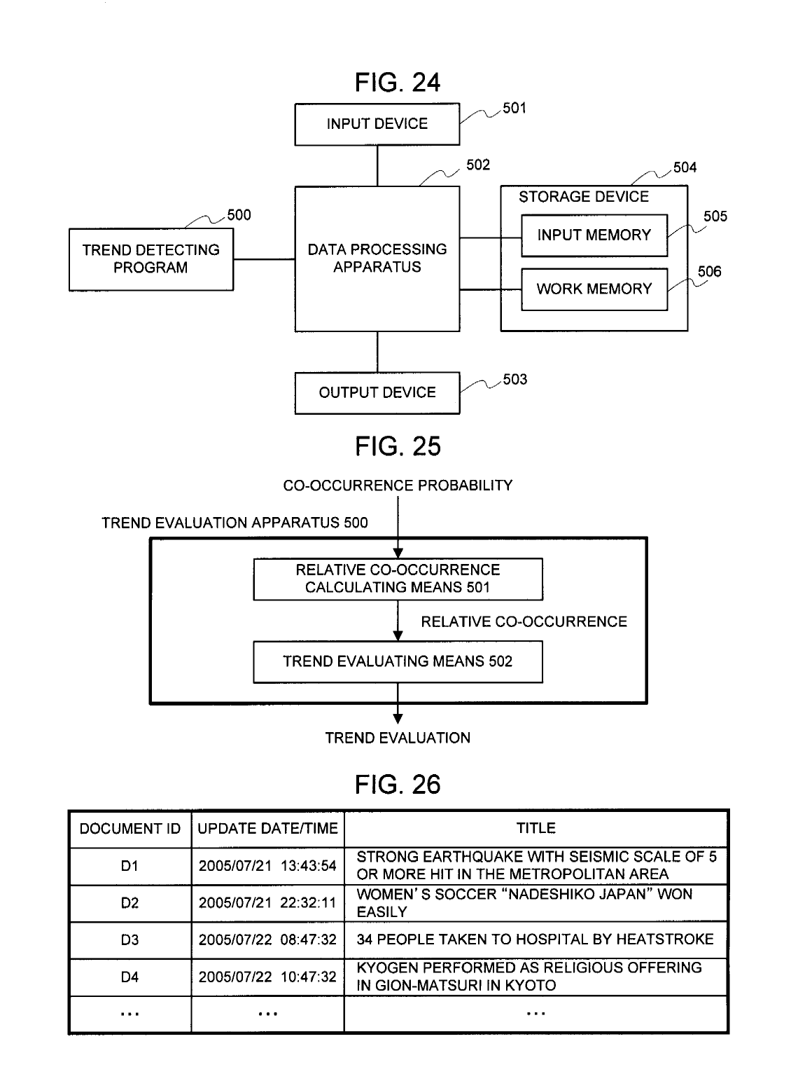

Referring to FIG. 24, the eighth embodiment of the present invention includes input device 501, data processing apparatus 502, output device 503, and a storage device 504. Moreover, it includes a trend detecting program 500 for implementing the trend evaluation apparatus 101 of the first embodiment.

The input device 501 is a device for inputting a command by an operator, such as a mouse, a keyboard, and the like. The output device 503 is a device for outputting a result of processing by the data processing apparatus 502 such as a display screen, a printer, and the like.

The trend detecting program 500 is loaded into the data processing apparatus 502 to control the operation of the data processing apparatus 502, and create an input memory 505 and a work memory 506 in the storage device 504. The data processing apparatus 502 performs the same processing as that of the first embodiment under the control of the program for implementing the trend evaluation apparatus 101.

The data processing apparatus 502 in FIG. 24 performs processing of the associated word extracting means 21, relative appearance calculating means 22, relative co-occurrence calculating means 23, relative associated word similarity calculating means 24, trend evaluating means 25, and trend visualizing means 26 in FIG. 1, and the storage device 504 in FIG. 24 stores therein the information in the time series text storage section 11, associated word storage section 12, and trend word storage section 13 in FIG. 1. While the time series text storage section 11 is implemented by employing data stored in the storage device 504, it may also be implemented by accessing an external database for acquisition of data via a network (for example, the Internet) by the data processing apparatus 502.

Next, a ninth embodiment of the present invention will be described in detail with reference to the accompanying drawings.

The ninth embodiment employs the configuration diagram in FIG. 24 as in the eighth embodiment. The trend detecting program 500 is loaded into the data processing apparatus 502 to control the operation of the data processing apparatus 502, and create an input memory 505 and a work memory 506 in the storage device 504. The data processing apparatus 502 performs the same processing as that of the second embodiment under the control of the program for implementing the trend evaluation apparatus 102.

The data processing apparatus 502 in FIG. 24 performs processing of the associated word extracting means 21, relative appearance calculating means 22, relative co-occurrence calculating means 23, relative associated word calculating means 24, trend evaluating means 25, and goods recommending means 27 in FIG. 8, and the storage device 504 in FIG. 24 stores therein the information in the time series text storage section 11, associated word storage section 12, trend word storage section 13, and goods information storage section 14 in FIG. 8. While the time series text storage section 11 and goods information storage section 14 is implemented by employing data stored in the storage device 504, they may also be implemented by accessing an external database for acquisition of data via a network (for example, the Internet) by the data processing apparatus 502.

Next, a tenth embodiment of the present invention will be described in detail with reference to the accompanying drawings.

The tenth embodiment employs the configuration diagram in FIG. 24 as in the eighth embodiment. The trend detecting program 500 is loaded into the data processing apparatus 502 to control the operation of the data processing apparatus 502, and create an input memory 505 and a work memory 506 in the storage device 504. The data processing apparatus 502 performs the same processing as that of the fifth embodiment under the control of the program for implementing the trend evaluation apparatus 103.

The data processing apparatus 502 in FIG. 24 performs processing of the associated word extracting means 21, relative appearance calculating means 22, relative co-occurrence calculating means 23, relative associated word calculating means 24, trend evaluating means 25, goods recommending means 27, and cyclicity deciding means 28 in FIG. 14, and the storage device 504 in FIG. 24 stores therein the information in the time series text storage section 11, associated word storage section 12, trend word storage section 13, and goods information storage section 14 in FIG. 14. While the time series text storage section 11 and goods information storage section 14 are implemented by employing data stored in the storage device 504, they may also be implemented by accessing an external database for acquisition of data via a network (for example, the Internet) by the data processing apparatus 502.

Next, an eleventh embodiment of the present invention will be described in detail with reference to the accompanying drawings.

The eleventh embodiment employs the configuration diagram in FIG. 24 as in the eighth embodiment. The trend detecting program 500 is loaded into the data processing apparatus 502 to control the operation of the data processing apparatus 502, and create an input memory 505 and a work memory 506 in the storage device 504. The data processing apparatus 502 performs the same processing as that of the sixth embodiment under the control of the program for implementing the trend evaluation apparatus 104.

The data processing apparatus 502 in FIG. 24 performs processing of the associated word extracting means 21, relative appearance calculating means 22, relative co-occurrence calculating means 23, relative associated word calculating means 24, trend evaluating means 25, goods recommending means 27, and second goods recommending means 29 in FIG. 17, and the storage device 504 in FIG. 24 stores therein the information in the time series text storage section 11, associated word storage section 12, trend word storage section 13, goods information storage section 14, and customer information storage section 15 in FIG. 17. While the time series text storage section 11, goods information storage section 14 and customer information storage section 15 are implemented by employing data stored in the storage device 504, they may also be implemented by accessing an external database for acquisition of data via a network (for example, the Internet) by the data processing apparatus 502.

Next, a twelfth embodiment of the present invention will be described in detail with reference to the accompanying drawings.

The twelfth embodiment employs the configuration diagram in FIG. 24 as in the eighth embodiment. The trend detecting program 500 is loaded into the data processing apparatus 502 to control the operation of the data processing apparatus 502, and create an input memory 505 and a work memory 506 in the storage device 504. The data processing apparatus 502 performs the same processing as that of the fifth embodiment under the control of the program for implementing the trend evaluation apparatus 105.

The data processing apparatus 502 in FIG. 24 performs processing of the associated word extracting means 21, relative appearance calculating means 22, relative co-occurrence calculating means 23, relative associated word calculating means 24, trend evaluating means 25, goods recommending means 27, and third goods recommending means 30 in FIG. 21, and the storage device 504 in FIG. 24 stores therein the information in the time series text storage section 11, associated word storage section 12, trend word storage section 13, goods information storage section 14, customer information storage section 15, and sales track record storage section 16 in FIG. 21. While the time series text storage section 11, goods information storage section 14, customer information storage section 15, and sales track record storage section 16 are implemented by employing data stored in the storage device 504, they may also be implemented by accessing an external database for acquisition of data via a network (for example, the Internet) by the data processing apparatus 502

The present invention may be applied to an application of automatically detecting information on a trend undergoing a significant change from several kinds of information sources, such as news stories, sports news, research papers, diaries, on-line forums, blogs, mailing lists, mail magazines, etc. The present invention may also be applied to recommendation or promotion of goods including products, TV programs, contents, restaurants, cosmetics, services, etc. associated with the detected trend.

1-60. (canceled)

61. A trend evaluation apparatus, characterized in that the apparatus has:
relative co-occurrence calculating means for calculating a relative co-occurrence that is an indication indicating a change in a co-occurrence probability of a keyword and an associated word of this keyword; and
trend evaluating means for evaluating a trend of said keyword based on the relative co-occurrence calculated by said relative co-occurrence calculating means.

62. A trend evaluation apparatus recited in claim 61, characterized in that said relative co-occurrence calculating means is means for calculating a relative co-occurrence from a ratio of a co-occurrence probability of the keyword and an associated word of this keyword in a period of time of interest to a co-occurrence probability of said keyword and an associated word of this keyword in a period of time for comparison.

63. A trend evaluation apparatus recited in claim 61, characterized in that said trend evaluating means is means for evaluating a combination of a keyword having the largest relative co-occurrence and an associated word of this keyword as a trend.

64. A trend evaluation apparatus recited in claim 61, characterized in that said trend evaluating means is means for evaluating a combination of a keyword having a relative co-occurrence which exceeds a predetermined threshold value and an associated word of this keyword as a trend.

65. A trend evaluation apparatus recited in claim 61, characterized in that said trend evaluating means is means for accumulating a relative co-occurrence within a predetermined period of time to obtain a variance value, and evaluating a combination of a keyword corresponding to said variance value which exceeds a predetermined threshold value and an associated word of this keyword as a trend.

66. A trend evaluation apparatus, characterized in that the apparatus has:
relative associated word similarity calculating means for calculating a relative associated word similarity that is an indication of a degree of a change in a topic for a keyword; and
trend evaluating means for evaluating a trend of said keyword based on the relative associated word similarity calculated by said relative associated word similarity calculating means.

67. A trend evaluation apparatus recited in claim 66, characterized in that said relative associated word similarity calculating means is means for calculating a relative associated word similarity from a cosine similarity of associated word collection vectors of a keyword in a period of time for comparison and associated word collection vectors of said keyword in a period of time of interest.

68. A trend evaluation apparatus recited in claim 66, characterized in that said trend evaluating means is means for evaluating a keyword having the smallest relative associated word similarity as a trend.

69. A trend evaluation apparatus recited in claim 66, characterized in that said trend evaluating means is means for evaluating a keyword having a relative associated word similarity smaller than a predetermined threshold value as a trend.

70. A trend evaluation apparatus recited in claim 66, characterized in that said trend evaluating means is means for accumulating a relative associated word similarity over a predetermined period of time to obtain a variance value thereof, and evaluating the relative associated word similarity corresponding to said variance value that exceeds a predetermined threshold value as a trend.

71. A trend evaluation apparatus, characterized in that the apparatus has:
relative co-occurrence calculating means for calculating a relative co-occurrence that is an indication indicating a change in a co-occurrence probability of a keyword and an associated word of this keyword;
relative associated word similarity calculating means for calculating a relative associated word similarity that is an indication of a degree of a change in a topic for said keyword; and
trend score calculating means for calculating a trend score for representing trendiness of said keyword in a numerical form based on the relative co-occurrence calculated by said relative co-occurrence calculating means and the relative associated word similarity calculated by said relative associated word similarity calculating means.

72. A trend evaluation apparatus recited in claim 71, characterized in that said apparatus has trend evaluating means for evaluating a trend of said keyword based on said trend score.

73. A trend evaluation apparatus recited in claim 71, characterized in that said apparatus has relative appearance calculating means for calculating relative appearance that is an indication of a degree of rise of attention to a keyword, and
said trend score calculating means calculates a trend score for representing trendiness of said keyword in a numerical form based on the relative co-occurrence calculated by said relative co-occurrence calculating means, the relative associated word similarity calculated by said relative associated word similarity calculating means and the relative appearance calculated by said relative appearance calculating means.

74. A trend evaluation apparatus recited in claim 71, characterized in that said relative appearance calculating means is means for calculating relative appearance from a ratio of an appearance probability of a keyword in a period of time of interest to an appearance probability of said keyword in a period of time for comparison.

75. A trend evaluation apparatus recited in claim 71, characterized in that said trend score calculating means calculates a trend score after weighting said relative co-occurrence, said relative associated word similarity or said relative appearance.

76. A trend evaluation apparatus recited in claim 71, characterized in that said apparatus has trend visualizing means for defining said relative co-occurrence, said relative associated word similarity or said relative appearance as a graphic and displaying it.

77. A trend evaluation apparatus recited in claim 72, characterized in that said apparatus has:
goods information storing means in which information on goods is stored; and
goods recommending means for searching goods associated with a keyword based on a result of said trend evaluating means from said goods information storing means, and proposing them.

78. A trend evaluation apparatus recited in claim 71, characterized in that said apparatus has cyclicity deciding means for deciding cyclicity of a trend score of a keyword, and correcting the trend score in accordance with the cyclicity.

79. A trend evaluation apparatus recited in claim 72, characterized in that said apparatus has:
goods information storing means in which information on goods is stored;
customer information storing means in which customer information on a customer is stored; and
goods recommending means for searching goods associated with a keyword based on a result of said trend evaluating means from said goods information storing means, and searching a customer to whom these goods are to be recommended from said customer information storing means based on said customer information and proposing them.

80. A trend evaluation apparatus recited in claim 79, characterized in that said apparatus has update means for updating customer information in said customer information storing means based on a sales track record.

81. A trend evaluation method comprises the steps of:
calculating a relative co-occurrence that is an indication indicating a change in a co-occurrence probability of a keyword and an associated word of this keyword; and
evaluating a trend of said keyword based on said calculated relative co-occurrence.

82. A trend evaluation method recited in claim 81, wherein said relative co-occurrence is a ratio of a co-occurrence probability of the keyword and an associated word of this keyword in a period of time of interest to a co-occurrence probability of said keyword and an associated word of this keyword in a period of time for comparison.

83. A trend evaluation method recited in claim 81, wherein said step of evaluating a trend comprises step of evaluating a combination of a keyword having the largest relative co-occurrence and an associated word of this keyword as a trend.

84. A trend evaluation method recited in claim 81, wherein said step of evaluating a trend comprises step of evaluating a combination of a keyword having a relative co-occurrence which exceeds a predetermined threshold value and an associated word of this keyword as a trend.

85. A trend evaluation method recited in claim 81, wherein said step of evaluating a trend comprises step of accumulating a relative co-occurrence within a predetermined period of time to obtain a variance value, and evaluating a combination of a keyword corresponding to said variance value which exceeds a predetermined threshold value and an associated word of this keyword as a trend.

86. A trend evaluation method comprises the steps of:
calculating a relative associated word similarity that is an indication of a degree of a change in a topic for a keyword; and
evaluating a trend of said keyword based on the calculated relative associated word similarity.

87. A trend evaluation method recited in claim 86, wherein said relative associated word similarity is calculated based on a cosine similarity of associated word collection vectors of a keyword in a period of time for comparison and associated word collection vectors of said keyword in a period of time of interest.

88. A trend evaluation method recited in claim 86, wherein said step of evaluating a trend comprises step of evaluating a keyword having the smallest relative associated word similarity as a trend.

89. A trend evaluation method recited in claim 86, wherein said step of evaluating a trend comprises step of evaluating a keyword having a relative associated word similarity smaller than a predetermined threshold value as a trend.

90. A trend evaluation method recited in claim 86, wherein said step of evaluating a trend comprises step of accumulating a relative associated word similarity over a predetermined period of time to obtain a variance value thereof, and evaluating the relative associated word similarity corresponding to said variance value that exceeds a predetermined threshold value as a trend.

91. A trend evaluation method comprises the steps of:
calculating a relative co-occurrence that is an indication indicating a change in a co-occurrence probability of a keyword and an associated word of this keyword;
calculating a relative associated word similarity that is an indication of a degree of a change in a topic for said keyword; and
calculating a trend score for representing trendiness of said keyword in a numerical form based on said calculated relative co-occurrence and said calculated the relative associated word similarity.

92. A trend evaluation method recited in claim 91, further comprises step of evaluating a trend of said keyword based on said trend score.

93. A trend evaluation method recited in claim 91, wherein said step of calculating a trend score comprises step of:
calculating relative appearance that is an indication of a degree of rise of attention to a keyword, and;
calculating a trend score for representing trendiness of said keyword in a numerical form based on said relative co-occurrence, said relative associated word similarity and the relative appearance.

94. A trend evaluation method recited in claim 91, wherein said relative appearance is calculated from a ratio of an appearance probability of a keyword in a period of time of interest to an appearance probability of said keyword in a period of time for comparison.

95. A trend evaluation method recited in claim 91, wherein said step of calculating a trend score comprises step of calculating a trend score after weighting said relative co-occurrence, said relative associated word similarity or said relative appearance.

96. A trend evaluation method recited in claim 91, further comprises step of defining said relative co-occurrence, said relative associated word similarity or said relative appearance as a graphic and displaying it.

97. A trend evaluation method recited in claim 92, further comprises step of searching goods associated with said evaluated keyword from goods information and proposing them.

98. A trend evaluation method recited in claim 91, further comprises step of deciding cyclicity of a trend score of a keyword, and correcting the trend score in accordance with the cyclicity.

99. A trend evaluation method recited in claim 92, further comprises steps of:
searching goods associated with said evaluated keyword from goods information; and
searching a customer to whom these goods are to be recommended from customer information.

100. A trend evaluation method recited in claim 99, further comprises step of updating customer information based on a sales track record.

101. A program for a trend evaluation, characterized in causing a computer to execute:
relative co-occurrence calculating process of calculating a relative co-occurrence that is an indication indicating a change in a co-occurrence probability of a keyword and an associated word of this keyword; and
trend evaluating process of evaluating a trend of said keyword based on the relative co-occurrence calculated by said relative co-occurrence calculating process.

102. A program recited in claim 101, characterized in that said relative co-occurrence calculating process is process of calculating a relative co-occurrence from a ratio of a co-occurrence probability of the keyword and an associated word of this keyword in a period of time of interest to a co-occurrence probability of said keyword and an associated word of this keyword in a period of time for comparison.

103. A program recited in claim 101, characterized in that said trend evaluating process is process of evaluating a combination of a keyword having the largest relative co-occurrence and an associated word of this keyword as a trend.

104. A program recited in claim 101, characterized in that said trend evaluating process is process of evaluating a combination of a keyword having a relative co-occurrence which exceeds a predetermined threshold value and an associated word of this keyword as a trend.

105. A program recited in claim 101, characterized in that said trend evaluating process is process of accumulating a relative co-occurrence within a predetermined period of time to obtain a variance value, and evaluating a combination of a keyword corresponding to said variance value which exceeds a predetermined threshold value and an associated word of this keyword as a trend.

106. A program for a trend evaluation, characterized in causing a computer to execute:
relative associated word similarity calculating process of calculating a relative associated word similarity that is an indication of a degree of a change in a topic for a keyword; and
trend evaluating process of evaluating a trend of said keyword based on the relative associated word similarity calculated by said relative associated word similarity calculating process.

107. A program recited in claim 106, characterized in that said relative associated word similarity calculating process is process of calculating a relative associated word similarity from a cosine similarity of associated word collection vectors of a keyword in a period of time for comparison and associated word collection vectors of said keyword in a period of time of interest.

108. A program recited in claim 106, characterized in that said trend evaluating process is process of evaluating a keyword having the smallest relative associated word similarity as a trend.

109. A program recited in claim 106, characterized in that said trend evaluating process is process of evaluating a keyword having a relative associated word similarity smaller than a predetermined threshold value as a trend.

110. A program recited in claim 106, characterized in that said trend evaluating process is process of accumulating a relative associated word similarity over a predetermined period of time to obtain a variance value thereof, and evaluating the relative associated word similarity corresponding to said variance value that exceeds a predetermined threshold value as a trend.

111. A program for a trend evaluation, characterized in causing a computer to execute:
relative co-occurrence calculating process of calculating a relative co-occurrence that is an indication indicating a change in a co-occurrence probability of a keyword and an associated word of this keyword;
relative associated word similarity calculating process of calculating a relative associated word similarity that is an indication of a degree of a change in a topic for said keyword; and
trend score calculating process of calculating a trend score for representing trendiness of said keyword in a numerical form based on the relative co-occurrence calculated by said relative co-occurrence calculating process and the relative associated word similarity calculated by said relative associated word similarity calculating process.

112. A program recited in claim 111, characterized in that said program has trend evaluating process of evaluating a trend of said keyword based on said trend score.

113. A program recited in claim 111, characterized in that said program has relative appearance calculating process of calculating relative appearance that is an indication of a degree of rise of attention to a keyword, and
said trend score calculating process calculates a trend score for representing trendiness of said keyword in a numerical form based on the relative co-occurrence calculated by said relative co-occurrence calculating process, the relative associated word similarity calculated by said relative associated word similarity calculating process and the relative appearance calculated by said relative appearance calculating process.

114. A program recited in claim 111, characterized in that said relative appearance calculating process is process of calculating relative appearance from a ratio of an appearance probability of a keyword in a period of time of interest to an appearance probability of said keyword in a period of time for comparison.

115. A program recited in claim 111, characterized in that said trend score calculating process calculates a trend score after weighting said relative co-occurrence, said relative associated word similarity or said relative appearance.

116. A program recited in claim 111, characterized in that said program has trend visualizing process of defining said relative co-occurrence, said relative associated word similarity or said relative appearance as a graphic and displaying it.

117. A program recited in claim 112, characterized in that said program has goods recommending process of searching goods associated with a keyword based on a result of said trend evaluating process from a goods information storing process in which information on goods is stored, and proposing them.

118. A program recited in claim 111, characterized in that said program has cyclicity deciding process of deciding cyclicity of a trend score of a keyword, and correcting the trend score in accordance with the cyclicity.

119. A program recited in claim 112, characterized in that said program has goods recommending process of:
searching goods associated with a keyword based on a result of said trend evaluating process from a goods information storing means in which information on goods is stored;
searching a customer to whom these goods are to be recommended from a customer information storing means in which customer information on a customer is stored; and
proposing them.

120. A program recited in claim 119, characterized in that said program has update process of updating customer information in said customer information storing process based on a sales track record.
